(19) United States
(12) Patent Application Publication
(10) Pub. No.: US 2011/0097814 A1
(43) Pub. Date: Apr. 28, 2011

(54) DETECTION DEVICES AND METHODS

(76) Inventors: G. Marco Bommarito, Stillwater, MN (US); Joseph J. Stoffel, Hastings, MN (US); Vinod P. Menon, Woodbury, MN (US); Brinda B. Lakshmi, Woodbury, MN (US); Timothy J. Diekmann, Maplewood, MN (US); Gustavo H. Castro, Cottage Grove, MN (US); Paul J. Cobian, Woodbury, MN (US); Raj Rajagopal, Woodbury, MN (US); Patrick A. Mach, Shorewood, MN (US)

(21) Appl. No.: 12/743,522

(22) PCT Filed: Nov. 20, 2008
(86) PCT No.: PCT/US08/84195

§ 371 Date: Dec. 30, 2010

Related U.S. Application Data
(60) Provisional application No. 60/989,291, filed on Nov. 20, 2007.

(51) Int. Cl. G01N 21/00; B01J 19/00

(52) U.S. Cl. 436/164; 422/69; 422/400

(57) ABSTRACT

The application discloses embodiments of detection devices including a sensor component in a flow path between a first flow path portion and a second flow path portion. In embodiments described, the sensor component includes a receptor in a polymerized composition. The receptor is configured to bind with an analyte in a test sample. Upon binding the sensor component undergoes a detectable change in response to interaction of the analyte with the receptor.

### CROSS REFERENCE TO RELATED APPLICATIONS

This application claims the benefit of U.S. Provisional Patent Application No. 60/989,291, filed Nov. 20, 2007, which is incorporated herein by reference.

### GOVERNMENT RIGHTS

The U.S. Government may have certain rights to this invention under the terms of Contract No. DAAD-13-03-C-0047 (Program No. 2640) granted by the Department of Defense.

### BACKGROUND

The emergence of bacteria having resistance to commonly used antibiotics is an increasing problem with serious implications for the treatment of infected individuals. Accordingly, it is of increasing importance to determine the presence of such bacteria at an early stage and in a relatively rapid manner to gain better control over such bacteria. This also applies to a variety of other microbes.

One such microbe of significant interest is Staphylococcus aureus (“S. aureus”). This is a pathogen causing a wide spectrum of infections including: superficial lesions such as small skin abscesses and wound infections; systemic and life threatening conditions such as endocarditis, pneumonia, and septicemia; as well as toxinoses such as food poisoning and toxic shock syndrome. Some strains (e.g., Methicillin-Resistant S. aureus) are resistant to all but a few select antibiotics.

Current techniques for the detection of microbes, particularly bacteria resistant to antibiotics, are generally time consuming and typically involve culturing the bacteria in pure form. One such technique for the identification of pathogenic staphylococci associated with acute infection, i.e., S. aureus in humans and animals and S. intermedius and S. hyicus in animals, is based on the microbe's ability to clot plasma. At least two different coagulase tests have been described: a tube test for free coagulase and a slide test for “cell bound coagulase” or clumping factor. The tube coagulase test typically involves mixing an overnight culture in brain heart infusion broth with reconstituted plasma, incubating the mixture for 4 hours and observing the tube for clot formation by slowly tilting the tube. Incubation of the test overnight has been recommended for S. aureus since a small number of strains may require longer than 4 hours for clot formation. The slide coagulase test is typically faster and more economical; however, 10% to 15% of S. aureus strains may yield a negative result, which requires that the isolate by reexamined by the tube test.

Although methods of detecting S. aureus, as well as other microbes, have been described in the art, there would be advantage in improved methods and devices for detection.

### SUMMARY

The application discloses embodiments of a detection device for detecting an analyte in a test sample, and optionally for sample preparation. In the illustrated embodiments, the detection device includes a sensor component in a flow path (between a first flow path portion and a second flow path portion). In embodiments described, the sensor component includes a receptor in a polymerized composition. The receptor is configured to bind with an analyte in a test sample. Upon binding, the sensor component undergoes a detectable change in response to interaction of the analyte with the receptor.

Preferred sensors described herein include colorimetric sensors. One preferred type of colorimetric sensor includes a polymerized composition comprising a diacetylene-containing polymer and a receptor, wherein the receptor is incorporated in the polymerized composition to form a transducer that provides a color change upon binding with one or more probes and/or analytes.

The devices described herein can be lateral-flow devices, vertical-flow devices, or a combination thereof. In certain embodiments, the sample flow path includes at least two portions (which can be defined by two or more sample passage portions), which are oriented in different directions. For example, one can be oriented transverse to the other. The sensor component is preferably in the device and within the flow path separating a first flow path portion from a second flow path portion. The sensor component can be in a patterned sensor layer in a form of one or more symbols or text.

Flow of a fluid (e.g., a test sample) can be induced along the flow path (i.e., from a first flow path portion to a second flow path portion) past the sensor component using a variety of techniques. For example, a pressure source can be used, such as a syringe, a vacuum source, an absorbent pad, or capillary pressure.

In one embodiment, there is provided a device for detecting the presence or absence of an analyte, the device comprising: a body including a flow path, a flow-through membrane, and a colorimetric sensor component disposed in or on the flow-through membrane; wherein the colorimetric sensor comprises a polymerized composition comprising a diacetylene-containing polymer and a receptor, wherein the receptor is incorporated in the polymerized composition to form a transducer that provides a color change upon binding with one or more probes and/or analytes.

In this embodiment, the device can further include one or more reagents for sample preparation disposed in one or more distinct zones of the sample flow path within the body of the device, wherein the one or more zones are disposed in the sample flow path upstream from the colorimetric sensor. The device can additionally, or alternatively, include one or more probes for indirect analyte detection disposed in one or more distinct zones of the sample flow path within the body of the device, wherein the one or more zones are disposed in the sample flow path upstream from the colorimetric sensor.

The flow path of this device can include a first flow passage portion and a second flow passage portion forming first and second flow path portions, wherein the flow-through membrane divides the first and second flow passage portions.

In one embodiment, there is provided a device for detecting the presence or absence of an analyte, the device comprising: a body including a flow path and a plurality of layers forming a multiple-layered structure, the flow path defined by a first flow passage portion and a second flow passage portion formed between a first layer and a second layer; and a sensor component disposed between the first and second layers, wherein the sensor component separates the first flow passage portion from the second flow passage portion.

The device of this embodiment can further include one or more intermediate layers between the first layer and the second layer, wherein the intermediate layer includes a patterned portion that forms at least one of the first and second flow passage portions. Preferably, a flow-through membrane is disposed in an opening in at least one of the intermediate layers. This multiple-layered structure can further include an absorbent layer or portion between an intermediate layer and an outer layer to induce flow across the flow-through membrane.

In a preferred embodiment, the multiple-layered structure of this device includes first and second outer layers, a spacer layer, and an intermediate layer, wherein the intermediate layer is disposed between the first and the second outer layers, and the spacer layer is disposed between the first outer layer and the intermediate layer and forms a first flow passage portion along the multiple-layered structure. Preferably, a flow-through membrane is disposed in an opening of the intermediate layer. This multiple-layered structure can further include an absorbent layer or portion between an intermediate layer and an outer layer to induce flow across the flow-through membrane.

In the multiple-layered devices of the present invention, a first (outer) layer can include a see-though portion to view the sensor component.

Preferably, the sensor component is disposed in or on a flow-through membrane between the first and second layers. If desired, the sensor component can be deposited in or on this flow-through membrane while in the presence of one or more target analytes and/or probes (i.e., during sample analysis).

In one embodiment, there is provided a device for detecting the presence or absence of an analyte, the device comprising: a body including a flow path and a plurality of layers forming a multiple-layered structure, the flow path defined by a first flow passage portion and a second flow passage portion formed between a first layer and a second layer; a patterned layer interposed between the first layer and the second layer, wherein the patterned layer forms a chamber, the first flow passage portion, and the second flow passage portion, and a sensor component disposed in the chamber formed by the patterned layer. The sensor component can be formed or deposited on a substrate enclosed within the chamber. Alternatively, the sensor component can be formed or deposited on at least one of the first layer or the second layer. If desired, the sensor component in disposed in or on a flow-through membrane within the chamber formed by the patterned layer.

In one embodiment, there is provided a device comprising: a sample flow path; a zone including a sensor component; one or more reagents for sample preparation disposed in one or more distinct zones of the sample flow path ahead of the sensor component; and optionally, a probe disposed in a distinct zone of the sample flow path ahead of the sensor component and different from the one or more sample preparation reagents. The sensor component, the one or more reagents, and/or the optional probe can be disposed on or in a flow-through membrane.

In one embodiment, there is provided a device for sample preparation and analysis of a target analyte, the device comprising: a sample flow path; one or more reagents for sample preparation disposed in one or more distinct zones of the sample flow path; a zone including a probe disposed in the sample flow path downstream from at least one of the sample preparation reagents; and a zone including a colorimetric sensor component, wherein the colorimetric sensor comprises a polymerized composition comprising a diacetylene-containing polymer and a receptor, wherein the receptor is incorporated in the polymerized composition to form a transducer that provides a color change upon binding with one or more probes and/or analytes.

Devices of the present invention can include one or more chambers, typically disposed within the first flow passage portion. Such chambers can include one or more sample preparation reagents and/or one or more probes (for an indirect assay) disposed therein. Additionally, the flow path and/or flow passage defining the flow path (particularly the first flow path and/or passage portion) is tortuous. This can facilitate mixing of the test sample with the sample preparation reagents and/or probes.

In one embodiment, there is provided a method comprising: providing a test sample suspected of containing one or more target analytes; providing a device as described herein, wherein the device comprises a sensor component prior to contact with a test sample; optionally, providing one or more probes suitable for an indirect assay of the one or more target analytes; inducing flow of a test sample from a first flow path portion to a second flow path portion downstream of the sensor component; exposing the test sample to the sensor component to bind one or more target analytes and/or one or more probes to the sensor component to induce a detectable change in the sensor component, if the target analytes are present in the test sample; and discerning the detectable change in the sensor component upon binding with the target analytes and/or probes. If desired, the one or more probes can be disposed in the device in the first flow path portion.

In another embodiment, there is provided a method of preparing and analyzing a sample for the presence or absence of an analyte, the method comprising: providing a test sample suspected of containing one or more target analytes; providing a device described herein, wherein the device comprises a sensor component and one or more sample preparation reagents; inducing flow of a test sample from a first flow path portion to a second flow path portion downstream of the sensor component; providing conditions effective for reaction between the test sample and at least one of the sample preparation reagents in the first flow path portion; exposing the test sample to the sensor component under conditions effective to bind an analyte and/or probe to the sensor component and produce a detectable change; and discerning the detectable change in the sensor component upon binding with the target analytes and/or probes.

The sensor components of any of the devices of the present invention are typically coated, deposited, or otherwise formed within the devices prior to use. Test samples with optional probes therein can then be introduced into the devices for interaction with the sensor components. Alternatively, however, the sensor components of the devices described herein can be deposited in or on a flow-through membrane (during sample analysis) while in the presence of one or more target analytes and/or probes.

For example, in one embodiment, there is provided a method of detecting the presence or absence of an analyte, the method comprising: providing a device comprising: a body including a flow path and a plurality of layers forming a multiple-layered structure, the flow path defined by a first flow passage portion and a second flow passage portion formed between a first layer and a second layer; and a flow-through membrane disposed between the first and second layers, wherein the flow-through membrane separates the first flow passage portion from the second flow passage portion; providing a test sample suspected of containing one or more target analytes; optionally, providing one or more probes suitable for an indirect assay of the one or more target analytes; providing a sensor component; combining the test sample, optional probes, and sensor component to form a mixture; inducing flow of the mixture from the first flow passage portion to the second flow passage portion across the flow-through membrane to collect the sensor component and bound target analytes and/or probes; and discerning the detectable change in the sensor component upon binding with the target analytes and/or probes.

In another embodiment, there is provided a method of detecting the presence or absence of an analyte, the method comprising: providing a device comprising: a body including a flow path and a plurality of layers forming a multiple-layered structure, the flow path defined by a first flow passage portion and a second flow passage portion formed between a first layer and a second layer; a patterned layer interposed between the first layer and the second layer, wherein the patterned layer forms a chamber, the first flow passage portion, and the second flow passage portion, and a flow-through membrane disposed in the chamber formed by the patterned layer; providing a test sample suspected of containing one or more target analytes; optionally, providing one or more probes suitable for an indirect assay of the one or more target analytes; providing a sensor component; combining the test sample, optional probes, and sensor component to form a mixture; inducing flow of the mixture from the first flow passage portion to the second flow passage portion across the flow-through membrane in the chamber to collect the sensor component and bound target analytes and/or probes; and discerning the detectable change in the sensor component upon binding with the target analytes and/or probes.

### Definitions

The terms “analyte” and “antigen” are used interchangeably and refer to small molecules, pathogenic, and non-pathogenic organisms, toxins, membrane receptors and fragments, volatile organic compounds, enzymes and enzyme substrates, antibodies, antigens, proteins, peptides, nucleic acids, and peptide nucleic acids. In certain preferred embodiments, they refer to various molecules (e.g., protein A) or epitopes of molecules (e.g., different binding sites of protein A), or whole cells of a microorganism, that are characteristic of the microorganism (i.e., microbe) of interest. These include components of cell walls (e.g., cell-wall proteins such as protein A, and Clumping Factor, which is a cell wall-associated fibrinogen receptor that is found in S. aureus), external cell components (e.g., capsular polysaccharides and cell-wall carbohydrates), internal cell components (e.g., cytoplasmic membrane proteins), etc.

The term “sensor component” refers to a material capable of exhibiting a detectable change upon binding with a target analyte in a direct assay or a probe designed for indirect assay of the target analyte. Typically, the sensor component includes a receptor incorporated in a polymerized composition. The receptor is typically designed to bind with the target analytes and/or probes.

The terms “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably.

The term “and/or” means one or all of the listed elements or a combination of any two or more of the listed elements.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

The disclosed subject matter will be further explained with reference to the attached figures, wherein like structure or system elements are referred to by like reference numerals throughout the several views.

FIG. 1 illustrates an embodiment of a sensor in solution in a test chamber.

FIG. 2 illustrates an embodiment of a sensor layer or portion on a substrate.

FIG. 3 illustrates a sensor component similar to FIG. 2 including a patterned sensor layer or portion.

FIG. 4 is a schematic illustration of a device including flow path and a sensor component.

FIG. 5 is a schematic illustration of a device including multiple flow paths and sensor components.

FIG. 6 is a schematic illustration of a device including a syringe or pressure source to induce flow along a flow path of the device.

FIG. 7 is a schematic illustration of a device including a vacuum source to induce flow along a flow path of the device.

FIG. 8 is an exploded view of a device including a multi-layered construction forming a flow path including a sensor component between a first flow passage portion and a second flow passage portion.

FIG. 9 is a schematic illustration of a device including multiple chambers along a flow path of the device.

FIGS. 10-11 schematically illustrate embodiments of a lateral-flow device including a flow-through membrane (i.e., porous membrane) which forms a flow path including a sensor component between a first flow path portion and a second flow path portion of the device.

FIG. 12 schematically illustrates an embodiment of a device including a sensor component on a flow-through membrane of the device.

FIG. 13 schematically illustrates an embodiment of a device including a sensor component on a flow-through membrane separating multiple flow path portions formed within a vial.

FIG. 14 schematically illustrates the sensor component or portion of the embodiment illustrated in FIG. 13.

FIG. 15 schematically illustrates an embodiment of a device having a multiple-layered structure and including a sensor component on a flow-through membrane.

FIG. 16 is an exploded view illustrating the multiple-layered construction (i.e., multi-layered structure) for a device of the type illustrated in FIG. 15.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art which fall within the scope and spirit of the principles of this disclosure.

### DETAILED DESCRIPTION OF ILLUSTRATIVE EMBODIMENTS

Embodiments illustrated herein relate to detection devices and methods to detect an analyte in a test sample. In certain embodiments, the present invention is directed towards devices and methods of also preparing the test sample for analysis.

Embodiments of the devices described herein include a sensor component that undergoes a detectable change (e.g., a color change) in response to reaction or binding with an analyte in a test sample. The devices can be used in methods that involve not only detecting the presence of an analyte, but preferably identifying such analyte, which, for example, can lead to identifying a microorganism for which the analyte is characteristic. In certain embodiments, analyzing the sample includes quantifying the analyte.

The sensor component typically includes a receptor incorporated in a polymerized composition. The receptor is typically designed to bind with the target analyte and/or probes desiged for an indirect assay of the target analytes. Upon binding, the polymerized composition undergoes a transformation or conformation to produce the detectable change to indicate the presence of the analyte in the test sample. The detectable change includes one of a color change, fluorescent change, or other detectable change that indicates the presence of the analyte. Other detectable changes include, for example, a change in conductance or resistance that is detected by a sensing device (not shown) such as a voltage or current device. A preferred change is a color change

A particularly preferred sensor component is a colorimetric sensor that includes a polymerized composition including a diacetylene-containing polymer and a receptor, wherein the receptor is incorporated in the polymerized composition to form a transducer that provides a color change upon binding with one or more probes and/or analytes, as described in further detail below. Suitable colorimetric sensors are described in Applicants' Assignee's Copending Application Ser. No. 60/989,298, filed on Nov. 20, 2007.

In the illustrated examples, the analyte can be detected in a direct or indirect mode to show the presence of a pathogen, organism, toxin, or other analyte of interest in the test sample. In an assay to detect a given target analyte, the sensor can function in solution or coated on a substrate, as described in further detail below.

Briefly, in solution, the sensor can be used in a direct or an indirect (competitive) assay. In the direct mode the analyte can directly bind to the sensor producing a detectable change, e.g., a color change. In the indirect mode, for example, a probe is first allowed to mix and interact with the analyte over a given incubation period. Typically, after completion of this step, a solution of the sensor is combined with the analyte-probe mixture. The remaining unbound probe can then bind to the colorimetric sensor producing a detectable change, such as a color change. Since the concentration of the unbound probe will be indirectly proportional to the concentration of analyte present originally, the detectable change produced is also indirectly proportional to the concentration of analyte, hence the indirect nature of this mode. If the detectable change resulting from assay carried out in solution is a color change, for example, it can be viewed visually, although in order to gain sensitivity, an appropriate fluidic system can be used to concentrate the colorimetric sensor material onto a solid phase, thus amplifying the color change.

For sensors coated on a substrate, analogous direct and indirect assays are also possible. In these assays rather than placing the sensor material in solution, the coated colorimetric sensor is exposed to a solution phase by employing an appropriate fluidic system.

### Preferred Colorimetric Sensor Polydiacetylene Assemblies

A preferred colorimetric sensor suitable for use in devices and methods of the present invention includes a polymerized composition including a receptor and a diacetylene-containing polymeric material (polydiacetylene assemblies), wherein the receptor is incorporated in the polymerized composition to form a transducer capable of providing a color change upon binding with one or more probe(s) and/or analyte(s). Such colorimetric sensors can serve as the basis for the colorimetric detection of a molecular recognition event.

Suitable diacetylene compounds for use in colorimetric sensors self assemble in solution to form ordered assemblies that can be polymerized using any actinic radiation such as, for example, electromagnetic radiation in the UV or visible range of the electromagnetic spectrum. Polymerization of the diacetylene compounds result in polymerization reaction products that have a color in the visible spectrum less than 570 nanometers (nm), between 570 nm and 600 nm, or greater than 600 nm, depending on their conformation and exposure to external factors. Typically, polymerization of the diacetylene compounds disclosed herein result in meta-stable blue phase polymer networks that include a polydiacetylene backbone. These meta-stable blue phase polymer networks undergo a color change from bluish to reddish-orange upon exposure to external factors such as heat, a change in solvent or counter ion, if available, or physical stress, for example.

The ability of the diacetylene compounds and their polymerization products disclosed herein to undergo a visible color change upon exposure to physical stress make them candidates for the preparation of sensing devices for detection of an analyte. The polydiacetylene assemblies formed from the disclosed diacetylene compounds can function as a transducer in biosensing applications.

The structural requirements of a diacetylenic molecule for a given sensing application are typically application specific. Features such as overall chain length, solubility, polarity, crystallinity, and presence of functional groups for further molecular modification all cooperatively determine a diacetylenic molecule's ability to serve as a useful sensing material.

For example, in the case of biodetection of an analyte in aqueous media, the structure of the diacetylenic compound should be capable of forming a stable dispersion in water, polymerizing efficiently to a colored material, incorporating appropriate receptor chemistry for binding to an analyte, and transducing that binding interaction by means of a color change. These abilities are dependent on the structural features of the diacetylene compounds.

The diacetylene compounds of the present invention possess the capabilities described above and can be easily and efficiently polymerized into polydiacetylene assemblies that undergo the desired color changes. Additionally, the diacetylene compounds allow for the incorporation of large excesses of unpolymerizable material, such as a receptor described below, while still forming a stable, polymerizable solution.

The disclosed diacetylene compounds can be synthesized in a rapid high-yielding fashion, including high-throughput methods of synthesis. The presence of functionality in the backbones of the diacetylenic compounds, such as heteroatoms for example, provides for the possibility of easy structural elaboration in order to meet the requirements of a given sensing application. The diacetylenic compounds can be polymerized into the desired polydiacetylene backbone containing network by adding the diacetylene to a suitable solvent, such as water for example, sonicating the mixture, and then irradiating the solution with ultraviolet light, typically at a wavelength of 254 nm. Upon polymerization the solution undergoes a color change to bluish-purple.

Diacetylenes useful in the present invention typically contain an average carbon chain length of 8 with at least one functional group such as a carboxyl group, primary and tertiary amine groups, methyl esters of carboxyl, etc. Suitable diacetylenes include those described in U.S. Pat. No. 5,491,097 (Ribi et al.); PCT Publication No. WO 02/00920; U.S. Pat. No. 6,306,598 and PCT Publication WO 01/71317.

In a preferred embodiment, the polydiacetylene assemblies are polymerized compounds of the formula

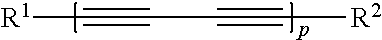

where R¹ is

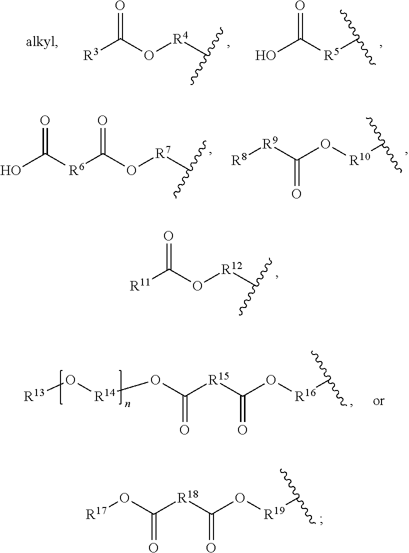

### R² is

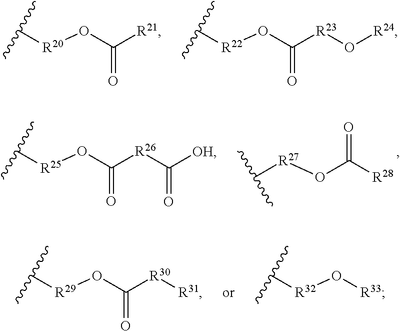

R³, R⁸, R¹³, R²¹, R²⁴, R³¹ and R³³ are independently alkyl; R⁴, R⁵, R⁷, R¹⁴, R¹⁶, R¹⁹, R²⁰, R²², R²⁵, and R³² are independently alkylene; R⁶, R¹⁵, R¹⁸, and R²⁶ are independently alkylene, alkenylene, or arylene; R⁹ is alkylene or —NR³⁴—; R¹⁰, R¹², R²⁷, and R²⁹ are independently alkylene or alkylene-arylene; R¹¹ and R²⁸ are independently alkynyl; R¹⁷ is an ester-activating group; R²³ is arylene; R³⁰ is alkylene or —NR³⁶—; R³⁴, and R³⁶ are independently H or C₁-C₄ alkyl; p is 1-5; and n is 1-20; and where R¹ and R² are not the same. Exemplary compounds are further described in U.S. Pat. No. 6,963,007 and U.S. Patent Application Publication Nos. 04-0126897-A1 and 04-0132217-A1. In a preferred embodiment, R¹ is

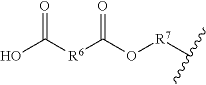

wherein R⁷ is ethylene, trimethylene, tetramethylene, pentamethylene, hexamethylene, heptamethylene, octamethylene, or nonamethylene, and R⁶ is ethylene, trimethylene, ethenylene, or phenylene; and wherein R² is

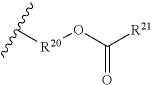

wherein R²⁰ is ethylene, trimethylene, tetramethylene, pentamethylene, hexamethylene, heptamethylene, octamethylene, or nonamethylene, and wherein R²¹ is undecyl, tridecyl, pentadecyl, heptadecyl; and wherein p is 1.

The invention is inclusive of the compounds described herein including isomers, such as structural isomers and geometric isomers, salts, solvates, polymorphs and the like.

Diacetylenes of the Formula XXIII can be prepared as outlined in Scheme 1 where n is typically 1 to 4 and m is typically 10 to 14.

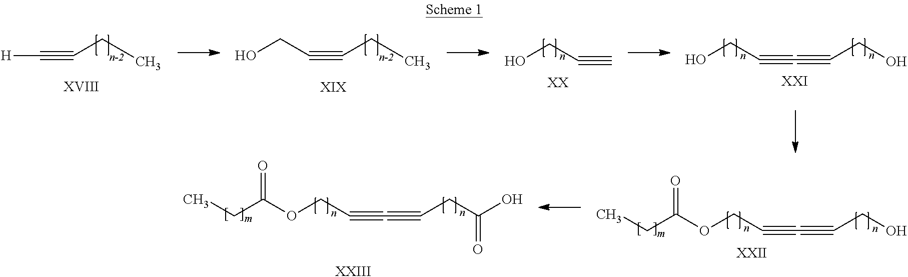

Compounds of formula XXIII can be prepared via oxidation from compounds of formula XXII by reaction with a suitable oxidizing agent in a suitable solvent such as DMF for example. Suitable oxidizing agents include Jones reagent and pyridinium dichromate for example. The aforesaid reaction is typically run for a period of time from 1 hour to 48 hours, generally 8 hours, at a temperature from 0° C. to 40° C., generally from 0° C. to 25° C.

Compounds of formula XXII can be prepared from compounds of formula XXI by reaction with a suitable acid chloride. Suitable acid chlorides include any acid chloride that affords the desired product such as lauroyl chloride, 1-dodecanoyl chloride, 1-tetradecanoyl chloride, 1-hexadecanoyl chloride, and 1-octadecanoyl chloride for example. Suitable solvents include ether, tetrahydrofuran, dichloromethane, and chloroform, for example. The aforesaid reaction is typically run for a period of time from 1 hour to 24 hours, generally 3 hours, at a temperature from 0° C. to 40° C., generally from 0° C. to 25° C., in the presence of a base such as trialkylamine or pyridine base.

Compounds of formula XXI are either commercially available (e.g. where n is 1-4) or can be prepared from compounds of the formula XVIII via compounds XIX and XX as outlined in Scheme 1 and disclosed in Abrams et al., Org. Synth., 66, 127-31 (1988) and Brandsma, Preparative Acetylenic Chemistry, (Elsevier Pub. Co., New York, 1971), for example.

Diacetylenic compounds as disclosed herein can also be prepared by reacting compounds of formula XXII with an anhydride such as succinic, glutaric, or phthalic anhydride in the presence of a suitable solvent such as toluene. The aforesaid reaction is typically run for a period of time from 1 hour to 24 hours, generally 15 hours, at a temperature from 50° C. to 125° C., generally from 100° C. to 125° C.

A sensor comprising the polydiacetylene assemblies can be obtained without the need to form a film by the conventional LB (Langmuir-Blodgett) process before transferring it onto an appropriate support. Alternatively, the polydiacetylene assemblies can be formed on a substrate using the known LB process as described in A. Ulman, An Introduction to Ultrathin Organic Films, Academic Press, New York, pp. 101-219 (1991).

### Preferred Colorimetric Sensor Receptors

The colorimetric sensor includes a transducer formed from a receptor incorporated within the polydiacetylene assemblies in solution. The sensor can be prepared by adding a receptor to the diacetylene monomers either prior to or after polymerization. The receptor is capable of functionalizing the polydiacetylene assemblies through a variety of means including physical mixing, covalent bonding, and non-covalent interactions (such as electrostatic interactions, polar interactions, etc).

Upon polymerization or thereafter, the receptor is effectively incorporated with the polymer network such that interaction of the receptor with an analyte or probe results in a visible color change due to the perturbation of the conjugated ene-yne polymer backbone.

The incorporation of the receptor with the polydiacetylene assembly provides a structural shape capable of deformation in response to interaction or binding with one or more probes and/or analytes. Particularly useful receptors are assemblies of amphiphilic molecules with typically a rod shape molecular architecture that can be characterized by a packing parameter defined as: v/(a₀l_{c}) (Israelachvili et al., Q. Rev. Biophys., 13, 121 (1980)), where v is the volume taken up by the hydrocarbon components of the molecules (for example, the hydrocarbon chains of a phospholipid or a fatty acid), a₀ is the effective area taken up by the polar headgroup (for example the phosphate headgroup of a phospholipid or the carboxylic acid headgroup of a fatty acid), and l_{c} is the so-called critical length, and generally describes the length of the molecule at the temperature of its environment. Preferred amphiphilic molecules for a receptor are those with packing parameters v/(a₀l_{c}) values between ⅓ and 1.

Examples of useful receptors include, but are not limited to, lipids, surface membrane proteins, enzymes, lectins, antibodies, antibody fragments, recombinant proteins, peptides, peptide fragments, etc.; synthetic proteins; nucleic acids, nucleic acid protein; c-glycosides; carbohydrates; gangliosides; and chelating agents. In most embodiments, the receptor is a phospholipid. Suitable phospholipids include phosphocholines (e.g., 1,2-dimeristoyl-sn-glycero-3-phosphocholine,); phosphoethanolamines; and phosphatidylethanolamines; phosphatidylserines; and phosphatidylglycerols such as those described in Silver, The Physical Chemistry of Membranes, Chapter 1, pp 1-24 (1985).

In one embodiment, the receptor is physically mixed and dispersed among the polydiacetylene to form a structure wherein the structure itself has a binding affinity for the probes and/or analytes of interest. Structures include, but are not limited to, liposomes, micelles, and lamellas. In a preferred embodiment, the structure is a liposome. While not intending to be bound by theory, it is believed that the phospholipid mimics a cell membrane while the polydiacetylene assemblies allow the physico-chemical changes occurring to the liposomes to be translated into a visible color change. The liposomes as prepared possess a well-defined morphology, size distribution and other physical characteristics such as a well-defined surface potential.

The ratio of receptor to diacetylene compounds in the liposome can be varied based on the selection of materials and the desired colorimetric response. In most embodiments, the ratio of phospholipids to diacetylene compound will be at least 25:75, and more preferably at least 40:60. In a preferred embodiment, the liposomes are composed of the diacetylene compound: HO(O)C(CH₂)₂C(O)O(CH₂)₄C≡C—C≡C(CH₂)₄O(O)C(CH₂)₁₂CH₃ [succinic acid mono-(12-tetradecanoyloxy-dodeca-5,7-diynyl)ester], and the zwitterionic phospholipid 1,2-dimeristoyl-sn-glycero-3-phosphocholine [DMPC] mixed in a 6:4 ratio.

The liposomes can be prepared by probe sonication of the material mixture suspended in a buffer solution that is referred to as the preparation buffer. For example, the preparation buffer can be a low ionic strength (5 mM) N-2-Hydroxyethylpiperazine-N′-2-ethanesulfonic acid [HEPES] buffer (pH=7.2). Another useful preparation buffer is a low ionic strength (2 mM) Tris Hydroxymethylaminoethane [TRIS] buffer (pH=8.5).

### Preferred Colorimetric Sensor Probes

The colorimetric sensor of the present invention is preferably designed to exploit the way one or more probes can interact with liposomes containing both a receptor, such as phospholipids, and polymerized diacetylenes. The liposomes can be thought as models for biological membranes and their interaction with probes, such as a protein, can be described as in Oellerich et al., J. Phys. Chem B, 108, 3871-3878 (2004); and Zuckermann et al., Biophysi. J., 81, 2458-2472 (2001).

It is convenient to describe the interaction of proteins with liposomes in terms of the lipid (partitioned in the liposome phase) to protein concentration ratio. At high lipid to protein concentration ratios, proteins will adsorb to the surface of the liposomes primarily through electrostatic interactions. As the protein concentration is increased, and the lipid to protein concentration ratio is lowered, proteins continue to adsorb electrostatically to the surface of a liposome until they completely saturate or envelop the liposomes. As this process proceeds, both liposomes and the proteins can undergo morphological and conformational changes, until the hydrophobic segment of the proteins covering the liposome surface can begin to interact with the hydrophobic interior of the liposome structure. At this point, the proteins can become hydrophobically bound and penetrate the liposome structure, resulting in substantial morphological change in the liposome structure, with the size and permeability of the liposomes changing drastically. Eventually, the layers of adsorbed proteins can result in the loss of suspension stability, via flocculation of the liposomes, and finally, precipitation of the lipid phase.

The presence of these electrostatic interactions is highly dependent not only on the type of proteins and lipids present but on their environment as well. Although not desiring to be bound by theory, it is believed that the ionic strength of a given buffer composition would be helpful in establishing the surface potential of both liposomes and charged proteins, and thus their ability to interact significantly electrostatically.

For example, in a buffer composition of low ionic strength (2-5 mM) at neutral pH (e.g., HEPES, TRIS), a charged probe can electrostatically adsorb to the polydiacetylene liposomes. Although the initial adsorption may not in itself trigger a substantial change in the size and morphology of the liposome, and thus an initially small or negligible colorimetric response, if the probe is present in excess to the lipid, it is likely that the probe will eventually become hydrophobically bound to the liposome and penetrate its interior membrane structure. At this point, one would expect that the large mechanical stresses imparted by the incorporation of the probe within the liposome structure would significantly change the polydiacetylene conformation, resulting in a concomitant colorimetric response readily observable.

Alternatively, if the probe is negatively charged at neutral pH its capacity to interact electrostatically with the polydiacetylene liposomes is severely hindered, and the ability to generate a colorimetric response due to a hydrophobic interaction between probe and the receptor-containing polydiacetylene liposomes may be compromised. In this event, using a high ionic strength buffer (greater than 100 millimolar (mM)) at neutral pH (e.g., phosphate buffer saline PBS, Imidazole buffer) would provide a mean to decrease the surface potential of the liposomes (by screening the surface charge of the liposome), facilitating the direct hydrophobic interaction of non-charged probes with the liposomes, and resulting in the incorporation of that protein within the structure of the liposome. Thus, in this case, the buffer composition assists in enabling a substantial colorimetric response, which would otherwise not take place. Although the higher ionic strength of the buffer composition, because of its effect on the surface potential of the liposomes, can introduce a significant colorimetric response in the absence of a probe, we have determined that when the probe is present, the colorimetric response is significantly enhanced due to the protein-liposome hydrophobic interactions. This result has very useful practical consequences: the detection time at a given limit of detection can be significantly shortened, or conversely, for a fixed assay time the limit of detection can be significantly lowered.

Based on this phenomena, the probe can be selected based on its ability to interact specifically with both a given analyte target and the polydiacetylene liposome to trigger a colorimetric response. The colorimetric response of the polydiacteylene-containing liposome is directly proportional to the concentration of the probe or a probe-analyte complex in those cases of direct analysis.

The selection of probe(s) for a particular application will depend in part on the probes' size, shape, charge, hydrophobicity and affinity towards molecules. The probes may be positively charged, negatively charged, or zwitterionic depending on the pH of the environment. At a pH below the isoelectric point of a probe, the probe is positively charged and above this point it is negatively charged. As used herein, the term “isoelectric point” refers to the pH at which the probe has a net charge of zero.

In order to design a biochemical assay with a polydiacetylene/phospholipid system, knowing the isoelectric point of the receptor (or probe) will affect the choice of buffer combinations. A probe with lower isoelectric point may require higher ionic strength buffers to obtain a change in morphology of the liposome. A higher isoelectric point protein can be used in low ionic strength buffer like HEPES buffer to produce a color change.

The probes can be any molecule with an affinity for both the target analyte and the receptor. Possible probes for use in the present invention include membrane disrupting peptides such as alamethicin, magainin, gramicidin, polymyxin B sulfate, and melittin; fibrinogen; streptavridin; antibodies; lectins; and combinations thereof. See, e.g., U.S. Patent Application Publication No. 2004/132217. A polymyxin, such as polymyxin B sulfate, is particularly useful for detecting Gram positive bacteria

Antibodies and antibody fragments can also be employed as the probe. This includes segments of proteolytically cleaved or recombinantly prepared portions of an antibody molecule that are capable of selectively reacting with a certain protein. Nonlimiting examples of such proteolytic and/or recombinant fragments include F(ab′), F(ab)₂, Fv, and single chain antibodies (scFv) containing a VL and/or VH domain joined by a peptide linker. The scFv's can be covalently or non-covalently linked to form antibodies having two or more binding sites. The scFv's can be covalently or non-covalently linked to form antibodies having two or more binding sites. Antibodies can be labeled with any detectable moieties known to one skilled in the art. In some aspects, the antibody that binds to an analyte one wishes to measure (the primary antibody) is not labeled, but is instead detected indirectly by binding of a labeled secondary antibody or other reagent that specifically binds to the primary antibody.

### Methods of Detection

In methods of the present invention, a test sample is typically collected or obtained from or with a sample collection device. In certain embodiments, the sample of material is typically eluted (or “released” or “washed”) from the sample collection device using a buffer solution such as by example, water, physiological saline, pH buffered solutions, or any other solutions or combinations of solutions that elute an analyte or sample from the sample acquisition device.

Examples of samples of interest (e.g., urine, wound exudates), targets and target analytes of interest (e.g., one or more analytes characteristic of a microorganism, particularly a bacterium, of interest), sample collection procedures, sample preparation procedures, sample preparation reagents, etc., that can be used with the devices and methods of the present invention are described in Applicants' Assignee's Copending Application Ser. No. 60/989,298, filed Nov. 20, 2007.

Methods for analysis of one or more analytes according to the present invention include direct and indirect methods. Preferred methods involve indirect detection.

In one embodiment, use of the above-mentioned colorimetric sensors provide direct absorption measurements or allow for visual observation with the naked eye to detect color change in the colorimetric sensor. In some cases, the probe can form a complex with the analyte which can interact directly with the sensor, yielding a direct assay where the colorimetric response is directly proportional to the concentration of analyte.

In an alternative embodiment, the present invention provides a method for indirect detection of an analyte by selection of a probe with an affinity to bind with both the receptor incorporated into the polydiacetylene assemblies and the analyte. The probe selected will demonstrate a competitive affinity with the analyte. When the analyte of interest is present, the probe will bind to the analyte rather than the receptor on the polydiacetylene backbone, resulting in a color change inversely proportional to the analyte concentration. If the analyte is absent, the probe will bind to the receptor incorporated on the polydiacetylene backbone. The probe can contact the sensor after the analyte contacts the sensor, or can be mixed with the analyte prior to the mixture contacting the sensor.

In one embodiment of an indirect detection assay, the probe and the target analyte are allowed to interact in a buffer solution, which is subsequently placed in contact with the sensor. The concentration of the probe free in the buffer is dependent on the amount of analyte target present: the higher the analyte concentration, the lower the remaining concentration of probe. Since the colorimetric response of the sensor is proportional to the amount of free probe available, the colorimetric response is inversely proportional to the analyte concentration.

In a particularly preferred embodiment of an indirect assay, a sensor component includes polydiacetylene liposomes that are configured to bind with a polymyxin B sulfate probe or other reagent to detect Gram negative or Gram positive bacteria. The polymyxin B sulfate probe is mixed with the test sample under mild agitation to bind to the bacteria. The polydiacetylene liposomes are used to detect the unbound polymyxin to indirectly detect the bacteria load of the test sample. The polydiacetylene sensor component undergoes a color change upon binding between the unbound polymyxin and the polydiacetylene liposomes where the color change is indirectly proportional to the concentration of bacteria in the test sample.

The detection assay typically also includes a buffer composition that mediates the interaction between the analyte(s) and the transducer. The buffer composition provides a system capable of resisting changes in pH in the presence of other components, consisting of a conjugate acid-base pair in which the ratio of proton acceptor to proton donor is near unity. In addition, the buffer compositions of the present invention mediate the physical or chemical interaction between the analyte and the components of the colorimetric sensor. For example, appropriate choice of the buffer composition can facilitate the interaction of a protein probe with the diacetylene liposomes, while inhibiting the interaction of other potentially interfering proteins that may be present in the sample. Buffer compositions that may be particularly useful include HEPES buffer, Imidazole buffer, and PBS buffer. Suitable buffer compositions are described in Applicants' Assignee's Copending Application Ser. No. 60/989,298, filed Nov. 20, 2007.

In one embodiment, the method of the invention comprises providing a test sample comprising the analyte in a buffer composition, providing a probe in a buffer composition, combining the test sample and the probe wherein the probe shows a greater binding affinity for the analyte than the receptor, and detecting the change with a biosensor.

In some assays, the probe could be generated in-situ by fragmenting or otherwise lysing the analyte target. The probe could also be considered a protein, protein fragment or other analyte externally present on the cell wall of an organism, specific for that organism that is available for interaction directly with the sensor. Interaction between the probe and the analyte can operate to the exclusion of interaction with the liposome, for example. Alternatively, the probe may interact with the analtye to form a complex, with the resulting complex interacting with the liposome. The probe can be contacted with the sensor in solution or coated on a substrate.

Using the indirect method of detection, high sensitivity that provides low levels of detection are possible based on the concentration of probe used. For this detection strategy, probe concentrations can be chosen to correspond to desired concentration levels of detection. The method of indirect detection using the probe allows design of the system around the type and concentration of the probe for desired sensitivity in a given application. This allows the transducer to be universal to multiple analytes of interest. For example, a single transducer (polydiacetylene/receptor combination) could serve to detect multiple analytes by varying the probe in contact with the transducer in accordance with the probe's affinity for the analyte.

In certain embodiments, the colorimetric sensor can be provided in a solution or suspension in a simple vial system, wherein an analyte can be added directly to a vial containing a solution with the transducer specific to the analyte of interest. Alternatively, the system could include multiple vials in a kit, with each vial containing a transducer comprising polydiacetylene assemblies with incorporated receptors particular to different analytes.

For those applications in which the analyte cannot be added directly to the polydiacetylene transducer, a two-part vial system could be used. One compartment of the vial could contain reagents for sample preparation of the analyte physically separated from the second compartment containing the transducer formed from the polydiacetylene assemblies. Once sample preparation is complete, the physical barrier separating the compartments would be removed to allow the analyte to mix with the transducer for detection.

Alternatively, a kit could also contain a vial for reagent storage and mixing of the analyte before contacting the colorimetric sensor coated on a two-dimensional substrate. In one embodiment, the kit could comprise a vial for reagent storage and analyte preparation, with a cap system containing the transducer of the present invention coated on a substrate.

A solution or suspension of a sensor can then be coated on a solid substrate by spotting the substrate and allowing the liquid carrier (e.g., water) to evaporate. Suitable substrates can include highly flat substrates, such as evaporated gold on atomically flat silicon (111) wafers, atomically flat silicon (111) wafers, or float glass, which are bare and modified with self-assembling monolayers (SAMs) to alter their surface energy in a systematic fashion; or substrates with a highly textured topography that include paper substrates, polymeric ink receptive coatings, structured polymeric films, microporous films, and membrane materials.

Alternatively, a solution or suspension of a sensor can be extruded through a membrane of appropriate pore size, entrapping the polydiacetylene assemblies and resulting in a coated membrane, which is subsequently allowed to dry. Appropriate membranes are generally those with pore size of 200 nm or less, comprising materials like polycarbonate, nylon, PTFE, polyethylene, etc.

These substrates can be either coated with a polymerized suspension of the diacetylene assemblies, or the suspension can be coated in the unpolymerized form and subsequently polymerized in the coated state. The coating weight of the sensor typically affects the sensitivity of the sensor. Ideally, the coating weight should be designed to bind with the analyte and undergo the detectable change in a reasonable time period. The coating weight should also preferably be uniform across the substrate to uniformly expose the test sample, for example, to the sensor component.

The colorimetric response from the polydiacetylene indicator is characterized by measuring hue angle (h°). The values of h° range from 0° to 360°, which essentially measures the RGB (red, green, blue) value of a given color. Pure red corresponds to an h° value of 0°, pure green corresponds to an h° value of 120°, and pure blue corresponds to an h° value of 240°. The color circle is continuous, therefore there is no discontinuity going from 360° to 0° (both values correspond to pure red). On average, the dynamic range of a preferred polydiacetylene indicator covers the interval of hue angles from approximately 260° (blue phase) to approximately 360° (red phase). The h° values were determined by direct measurements of the color using a commercial spectrophotometer (Avantes AvaSpec-2048-SPU2-SD256 available from Wilkens-anderson Co., Chicago, Ill.).

Various forms of the colorimetric sensor can be used, including, for example, tape or label form. See, e.g., U.S. Patent Application Publication No. 2004/132217.

In certain embodiments, the colorimetric sensors of the present invention could be paired with other known diagnostic methods to provide a multi-prong determination of the presence of analytes characteristic of bacteria or other analytes of interest.

### Device Designs

The colorimetric sensor can function in solution or be coated on a substrate. Preferably, in devices shown herein, a sensor can be included within the device. For example, a sensor component can be disposed on a membrane in a sample flow path. Alternatively, or additionally, various sample preparation reagents or other reagents used in detection (e.g., probes) as described in Applicants' Assignee's Copending Application Ser. No. 60/989,298, filed Nov. 20, 2007, can be disposed in the devices described herein.

In one embodiment of the invention, the various reagents as discussed herein can be disposed in dry form in a solid or semi-solid form. Such reagents can be dried down using various techniques, such as vacuum drying, and equipment, such as a convection oven and lyophilization. For drying down reagents, a drying diluent can be used. An exemplary drying diluent can include, for example, a buffer (e.g., phosphate buffer), a disaccharide (e.g., trehalose, sucrose) and polysaccharide (e.g., glycerol) specific to conjugate, and a preservative (e.g., sodium azide).

The use of devices having reagents therein (particularly, dried-down reagents therein in solid or semi-solid form) can provide greater efficiency, less sample contamination, less sample loss through transfer, better stability, and longer shelf life.

For example, in one portion of the device, a surface may be coated with a polymyxin-containing solution and optionally dried, and in a downstream portion of the device, a surface may be coated with a colorimetric sensor and optionally dried. As the test sample flows through the device along its flow path, it will come into contact first with the probe forming a mixture of the test sample and probe, and this mixture will then flow further along its flow path to contact the colorimetric sensor. In this way, the probe interacts with the test sample containing the analyte before contacting the colorimetric sensor.

The following discussion of exemplary embodiments includes a sensor (i.e., sensor component) disposed in a device in a sample flow path. Alternatively or additionally, other reagents used in detection (e.g., probes) and/or reagents used in sample preparation (e.g., lysing agents) can be disposed in the device in the sample flow path. Such reagents can be in solid or semi-solid form.

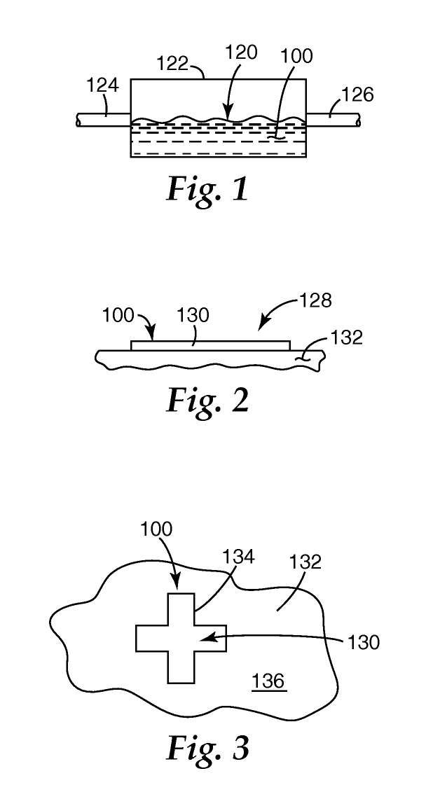

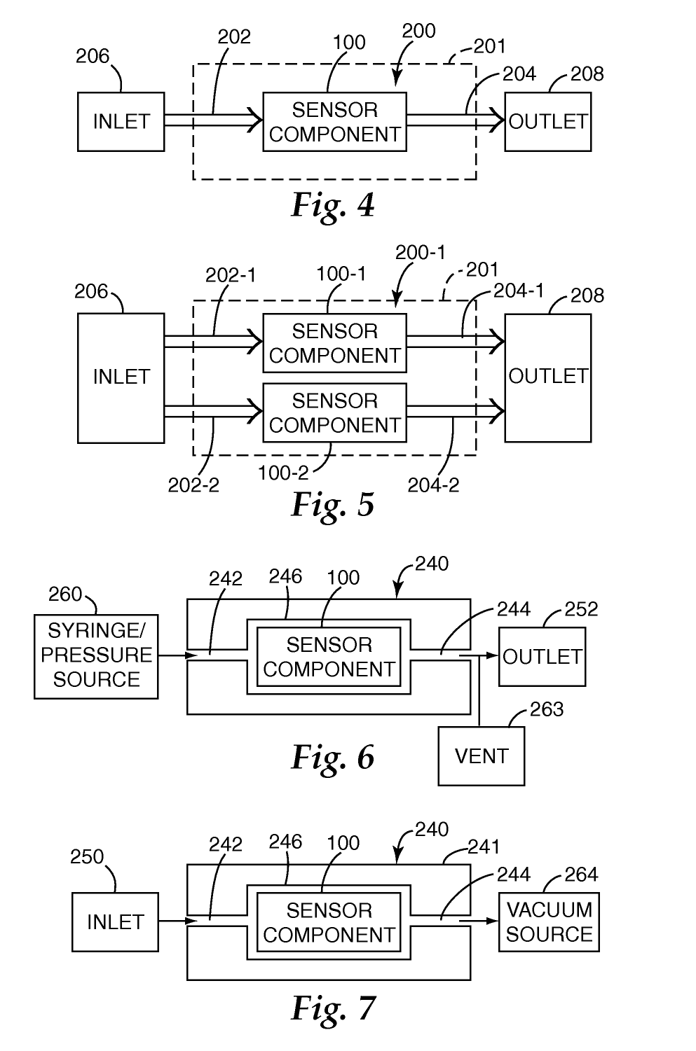

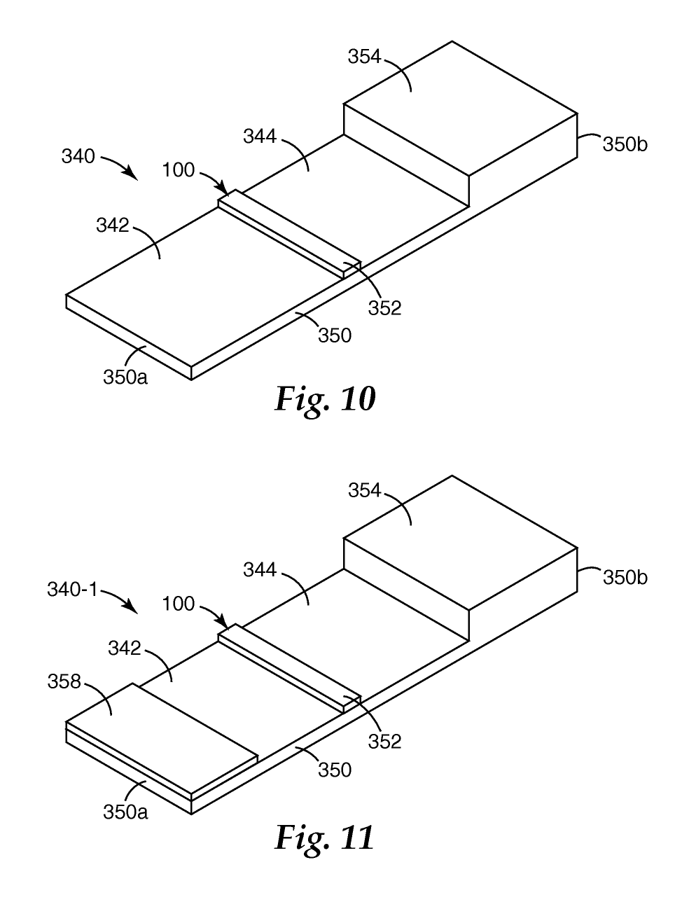

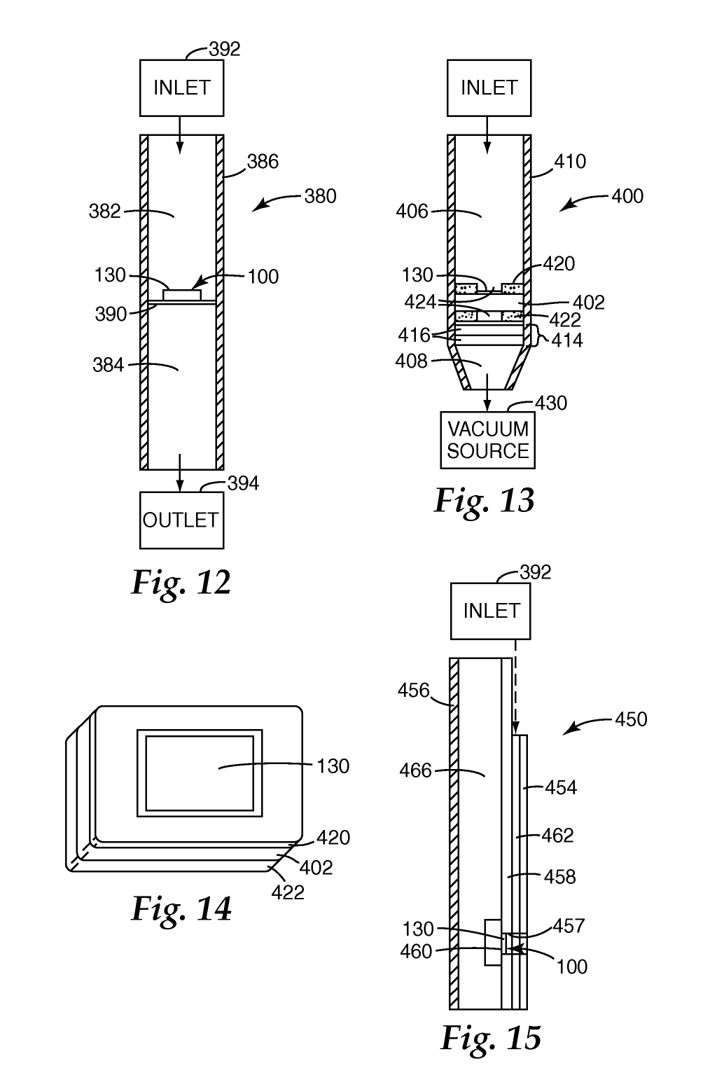

FIGS. 1-7, 10, and 12 are generalized structures for greater understanding of the general concept of the sensor component being in a flow path of a fluidic device: in solution (FIG. 1); in solid form (FIG. 2); in the form of a design (FIG. 3); in one or more flow passages that create one or more flow paths (FIGS. 4-5); with optional flow generators (e.g., syringe/pressure/vacuum sources) shown (FIGS. 6-7); in a lateral-flow format (FIG. 10); or in a gravity-fed system (FIG. 12). Such embodiments are discussed in terms of a colorimetric sensor, although other sensors may be suitable for use in the devices described herein.

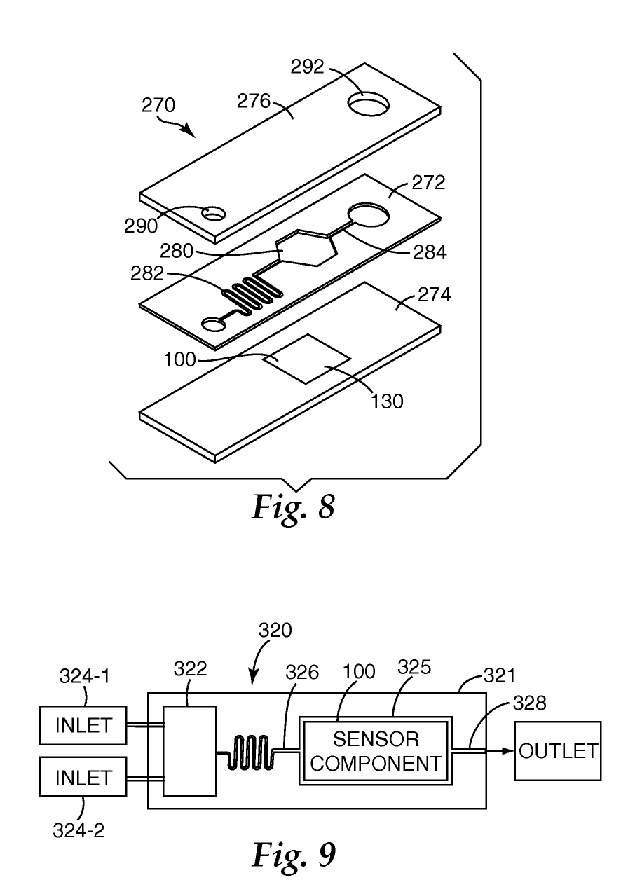

FIGS. 8-9, 11, and 13-16 are more detailed structures for greater understanding of actual devices, how they are made, and how they would be used in methods described herein.

In general terms, as shown in FIG. 1, the sensor (i.e., sensor component) 100 is in solution 120 in a sensor chamber 122. As shown, the chamber 122 can be disposed in a flow path between a first flow path portion 124 and a second flow path portion 126. A test sample suspected of containing an analyte of interest flows into chamber 122 to mix with the solution 120. Upon mixing, the analyte of interest, if present in the test sample, binds with the receptor of the sensor component 100 to produce the detectable change, for example, in a direct assay.

The color change resulting from an assay carried out in solution can be visually detected. Alternatively, if greater sensitivity is desired, an appropriate fluidic system can be used to concentrate the colorimetric sensor material onto a solid phase, thus amplifying the color change.

FIG. 2 illustrates an exemplary embodiment wherein the sensor component 100 is formed of a sensor layer or portion 130 on a substrate 132, such as a thin film membrane, porous membrane (i.e., flow-through membrane), or other substrate. In one example, the sensor layer or portion 130 preferably includes polydiacetylene liposomes deposited on a thin film membrane or other substrate.

In the embodiment illustrated in FIG. 3, the sensor layer or portion 130 is deposited on the substrate 132 in a particular pattern to form one or more symbols or alphanumeric text 134. For example, in the illustrated embodiment, the sensor layer or portion 130 is formed in the pattern of a “+” symbol 134 to indicate a positive test result. Upon binding with the analyte or probe, the “+” symbol 134 becomes visible relative to a background portion 136 to indicate a positive test result. The pattern of the symbol or text 134 is formed via known masking techniques to produce the deposited sensor layer or portion in the desired pattern and background portion 136 without the sensor layer or portion 130. Although FIG. 3 illustrates a “+” sign, application is not limited to any particular symbol or text.

The devices described herein utilize the sensor component 100 as previously described to detect the presence of a target analyte in a test sample using, for example, a direct assay or indirect assay. For an indirect assay, in addition to the sensor component being disposed in the devices described herein, one or more probes may be disposed within the devices upstream of the sensor component.

FIG. 4 schematically illustrates one embodiment wherein a detection device 200 of the present application including a sensor component 100 on a body 201 of the device 200. In the device 200 shown, the sensor component 100 is disposed in a flow path (between a first flow path portion 202 and a second flow path portion 204) of the device 200. During use, a test sample flows along the first flow path portion 202 past the sensor component 100 and then along the second flow path portion 204. As the test sample flows past the sensor component 100, the analyte or probe binds with the receptor contained within the sensor component 100 to produce the detectable change. As shown, the sample is injected into the flow path at inlet 206 and is collected or discharged from the second flow path portion 204 at outlet 208.

Although not shown, a probe may be disposed in the sample flow path within the device upstream of the sensor component (i.e., in the first flow path portion 202). Additionally, one or more sample preparation reagents may be disposed in the sample flow path within the device upstream of the sensor component (i.e., in the first flow path portion 202). The sample flow path portions, particularly the upstream or first flow path portion 202 can be tortuous, thereby facilitating mixing of the sample with any sample preparation reagents used (whether they are disposed in the device or not).

As shown in FIG. 4, the flow path for the test sample includes both a flow path portion upstream and downstream of the sensor component 100 to induce flow past the sensor component 100 for contact between the analyte(s) in the test sample and the sensor component 100 to produce a detectable change. The downstream portion is typically the waste stream. The reaction time and interaction between the analyte(s), any sample preparation reagents (if disposed in the device), a probe (if used and disposed in the device), and the sensor component 100 is controlled based upon the flow rate of the sample past the sensor component 100 and other variables discussed herein.

FIG. 5 schematically illustrates the device illustrated in FIG. 4, which includes multiple sensor components 100-1, 100-2 on the same device 200-1 to detect the same or different analyte using a single device. For example, in a direct assay, the receptors contained within sensor components 100-1 and 100-2 can bind with different analytes in the test sample to detect the presence of different analyte(s) (characteristic of different organisms or substances) in the test sample or can bind to the same analyte(s). As shown in FIG. 5, sensors 100-1, 100-2 are also interposed in flow paths between the first flow path portions 202-1, 202-2 and the second flow path portions 204-1, 204-2, respectively. The test sample is introduced into the first flow path portions 202-1, 202-2 via inlet 206 and is discharged from the second flow path portions 204-1, 204-2 at outlet 208. Although FIG. 5 illustrates a single inlet 206 and outlet 208, multiple inlets and outlets can be used if desired for the multiple flow paths.

FIGS. 6-7 illustrate embodiments of a detection device 240 where the flow path is formed by a flow passage, which extends through a body 241 of the device. As shown, the flow passage includes a first flow passage portion 242 and a second flow passage portion 244. As shown, the first flow passage portion 242 is upstream of chamber 246 and the second flow passage portion 244 is downstream of the chamber 246. Sensor component 100 is disposed in the chamber 246 in the flow path between the first flow passage portion 242 and the second flow passage portion 244. The test sample is injected into the first flow passage portion 242 flows from the first flow passage portion 242 through chamber 246 past the sensor component 100 in chamber 246 to the second flow passage portion 244. Flow of the test sample past the sensor component 100 allows the analyte to bind with the receptor in the sensor component to produce the detectable change responsive to the presence of the analyte or probe, as previously described.

In the illustrated devices, the sensitivity of the sensor component 100 is influenced by various factors including, for example, coating weight, flow rate of the test sample, concentration of the analyte or probe, binding rate of the analyte or probe, the cross sectional area of the flow path or passage and the pressure drop across the sensor component 100 or along the flow passage or path. Binding of a probe or analyte to the liposomes is proportional to the binding rate k of the probe or analyte and the concentration or dose of the probe or analyte and receptor. The concentration or dose of the reagent probe or sample is proportional to:

$$Dose α \sqrt{\frac{D}{λ F}}$$

where D is the diffusion coefficient;

l is the length; and

F is the flow rate;

where MW is the molecular weight of the probe in an indirect assay or the analyte in a direct assay.

The pressure drop can be approximated by the Hagen-Poiseuille equation. Preferably the most significant pressure drop should be across the sensor component to enhance binding.

Useful flow rates range from 2.5 microliters per minute (μL/min) to 1000 μL/min, most preferred flow rates are in the range from 25 μL/min to 250 μL/min.

In each of the illustrated embodiments, a time or period of exposure of the test sample to the sensor component 100 is limited based upon the flow rate of the test sample across the sensor component 100. Once the fluid flows past the sensor component 100 it is no longer exposed to the sensor layer or portion, thus limiting exposure of the test sample to the sensor component 100 to provide a relatively stable test result which does not vary significantly following conclusion of the test.

The embodiments of the invention have particular application for low molecular weight probes used in an indirect assay, or analytes detected directly (less than 10 kDA) where a limit of detection of 5 nmoles/mL in less than 10 minutes is possible and for samples smaller than 100 μL. To limit non-specific binding, an additional blocking agent (such as bovine serum albumin, a disaccharide (e.g., sucrose, trehalose)) can be used.

Flow through the flow passage portions, or flow along the flow path portions, can be induced by gravity or via capillary pressure, for example. Capillary flow can be imparted via a porous media or polymeric foam or through capillary channels or passages. The size and area of the passages can be designed to provide desired flow across the sensor component.

Alternatively, flow can be actively induced via a pressure device or other pressure source as illustrated in FIGS. 6-7. In the embodiment schematically shown in FIG. 6, a syringe 260 is used to inject the test sample into the first flow passage portion 242. The test sample is injected via syringe 260 under pressure to induce fluid flow along the flow path through the first flow passage portion 242, the chamber 246, and the second flow passage portion 244. As shown in FIG. 6, the device includes a vent 263 open to the second flow passage portion 244 to allow escape of entrapped air or bubbles. The vent 263 can be an opening in fluid communication with the second flow passage portion 244 with a permeable or semi-permeable covering or opening with no covering. Alternatively, other techniques or devices can be used to reduce entrapped air bubbles or gas including, for example, priming techniques or release valves. In another example, the device itself can be oriented during testing so that air bubbles are naturally displaced.

In another embodiment illustrated in FIG. 7, fluid flow can be induced via a vacuum source 264. Vacuum sources of particular interest in these devices include, but are not limited to, those that rely on a mechanical action to generate a vacuum. For example, spring loaded mechanisms activated by the user in the form of levers or buttons; compressed elastomeric bladders that are allowed to regain their uncompressed state through a user activated action (such as the removal of a pressure sensitive adhesive strip). As shown, the vacuum source 264 is coupled to the second flow passage portion 244 to induce fluid flow along the flow path or flow passage.

FIG. 8 illustrates an exploded view of a detection device 270 formed of a multi-layered structure. The multi-layered construction forms a flow path including a sensor component between a first flow passage portion and a second flow passage portion. More specifically, the multiple-layered structure of the illustrated device includes a patterned layer 272 that is interposed between a first or bottom layer 274 and a second or top layer 276. Illustratively, the patterned layer 272 may be a die cut film layer. The pattern (i.e., flow passage) on layer 272 forms chamber 280, first flow passage portion 282 and second flow passage portion 284 when the layers 272, 274, 276 are assembled. The first layer or top layer 276 includes an inlet opening 290 and an outlet opening 292 to provide an inlet to the first flow passage and an outlet from the second flow passage portion 284, respectively.

In the illustrated embodiment, the layers can be fabricated of a polyethylene terephthalate (PET) material, although numerous other materials could be used if desired, including polyethylene, polypropolyne, and polycarbonate. The first and second layers 274, 276 are assembled or connected to the patterned layer 272. This can be done using a variety of techniques (e.g., adhesive layers, hot meltable films, heat sealing films, ultrasonic welding), with adhesives, such as pressure sensitive adhesives, being preferred. Such layers, e.g., adhesive layers or hot meltable film layers, would typically be illustrated as separate layers, which may or may not be pattern coated, however, such layers are not shown in FIG. 8.

In the embodiment shown in FIG. 8, a sensor component 100 is disposed in chamber (i.e., reservoir or well) 280. In the illustrated embodiment, the sensor component 100 includes a layer or portion 130 deposited or coated on layer 274 of the multiple layer structure. Alternatively, the sensor layer or portion can be formed or deposited on layer 276 or on a separate substrate, which is enclosed in chamber 280.

The embodiment shown in FIG. 8 could be used in either an indirect or a direct assay. In an indirect assay, the analyte would typically be first mixed with a probe in a vial and then introduced in the device of FIG. 8 by using a pipette or a syringe. Flow could be either passive or active. In a passive mode once introduced the sample flows through the device under capillary action; while in an active mode a syringe could be used to either push or draw the sample through the device. As the probe/analyte mixture passes over the sensor component 100 enclosed in the chamber 280, probe that is not bound to the target analyte can diffusively reach the sensor component 100 and induce a visible color change. Typically, the color change occurs first at the leading edge of the flow (hence at the upstream end of the chamber 280) and progressively moves downstream to the back of the chamber 280. The concentration of the analyte in the sample can be measured by the length of the sensor component 100 that undergoes a color change, where the total length that undergoes a color change from blue to red is indirectly proportional to the concentration of the analyte present in the sample.

In a direct assay, the sensor component 100 includes a receptor such that when the analyte contacts the sensor component 100 it binds to this receptor and triggers a visible color change in the sensor component 100. In this case the sample can be simply introduced in the device of FIG. 8 by using a pipette or a syringe. As in the indirect assay, flow could be either passive or active. Detection is visualized in a manner identical to that described above for the indirect assay with the only difference being that in a direct assay the total length that undergoes a color change from blue to red is directly proportional to the concentration of the analyte present in the sample.

As shown, the first flow passage portion 282 of the patterned layer 272 includes a tortuous path. The tortuous path can facilitate mixing or agitation of the test sample along the flow path. The tortuous path can be used to facilitate mixing of a test sample with a sample preparation reagent and/or probe, for example. Such sample preparation reagents and/or probes can be premixed with the sample before it is applied to the device. Alternatively, they may be disposed (e.g., in solid or semi-solid form) in the sample flow path (e.g., within the tortuous path of the first flow passage portion 282.

Channels as small as 500-μm wide by 25-μm thick can be fabricated using a multiple-layered structure of the type illustrated in FIG. 8. For example, the patterned layer 272 illustrated in FIG. 8 can vary from 50-μm to150-μm thick. The thickness of the layers 272, 274, 276 are preferably sufficient to limit distortion to provide a uniform channel area across a width of the flow passage. One or more of the layers may be rigid if desired. An example of a rigid layer is a glass layer or wafer. Such rigid layer could reduce the amount of bowing of the center of the flow passage or chamber, and thereby provide desired flow parameters for the device.

FIG. 9 illustrates a detection device 320 in which the sample is both mixed and tested in a single device. As shown in FIG. 9, the illustrated device 320 includes a mixing chamber 322 formed on a body 321 of the device to mix the test sample and probe or other sample preparation reagent prior to testing. In the illustrated embodiment, the mixing chamber 322 receives fluid from the multiple inlets 324-1, 324-2 for the test sample (or eluted sample) and probe or sample preparation reagent. The mixing chamber 322 is coupled to chamber 325 having the sensor component 100 via a first flow passage portion 326 of the flow path. The mixture from the mixing chamber 322 flows through the first flow passage portion 326 to chamber 325. The mixture then flows through chamber 325 to the second flow passage portion 328.

As the mixture flows through chamber 325, the analyte or probe binds with the receptor 108 of the sensor component 100 to produce the detectable change 102. As shown, the first flow passage portion 324 is tortuous to facilitate mixing of the sample and probe or sample preparation reagent prior to contact with the sensor component 100. In an alternative embodiment, the device includes only one inlet to introduce both a test sample and sample preparation reagent or probe. In the embodiment shown, flow can be induced passively or via a pressure source or device, as previously described. Alternatively, the mixing chamber or other chamber along the flow path can be formed of a squeezable construction so that upon application of pressure fluid is expressed from chamber 322 or chamber 325 to induce fluid flow along the flow path as described.

In alternative embodiments, the sample preparation reagent or probe is disposed along the flow path or in the mixing chamber 322. Upon contact the sample preparation reagent interacts with the sample, for example, to release analyte. Released analyte can then bind with a probe (in an indirect analysis), which then moves along the flow path to interact with the sensor component. In an illustrated embodiment, the sample preparation reagent or probe can be disposed in a solid or semi-solid form (e.g., dehydrated form). The reagent or probe is then hydrated and mixes with the test sample prior to detection.

The embodiment shown in FIG. 9 could be used in either an indirect or a direct assay. In an indirect assay, the analyte and the probe would be introduced in the corresponding inlets 324-1 and 324-2 of device of FIG. 9 by using a pipette or a syringe, for example. Flow could be either passive or active as described above. The probe and analyte come together in the mixing chamber 322 and are further mixed while flowing through the tortuous path of the first passage portion 324. As the probe/analyte mixture passes over the sensor component 100 enclosed in the chamber 325, probe that is not bound to the target analyte can diffusively reach the sensor component 100 and induce a visible color change. Typically, the color change occurs first at the leading edge of the flow (hence at the upstream end of the chamber 325) and progressively moves downstream to the back of the chamber 325. The concentration of the analyte in the sample can be measured by the length of the sensor component 100 that underwent a color change, where the total length that undergoes a color change from blue to red is indirectly proportional to the concentration of the analyte present in the sample.

In a direct assay, the sensor component 100 includes a receptor such that when the analyte contacts the sensor component 100 it binds to this receptor and triggers a visible color change in the sensor component 100. In this case the sample can be simply introduced in one of the inlets 324-1 the device of FIG. 9 by using a pipette or a syringe. A sample preparation reagent may be necessary for direct detection of the analyte. For example, the target analyte may need to be lysed in order to release a protein target that is detectable. Such a lysing agent could be introduced in the second inlet 324-2 of the device of FIG. 9. As in the indirect assay, flow could be either passive or active. The analyte and the sample preparation reagent come together in the mixing chamber 322 and are further mixed while flowing through the tortuous path of the first passage portion 324. The target released via lysing of the sample can then be detected in a manner identical to that described above for the indirect assay with the only difference being that in a direct assay the total length (of the sensor component) that undergoes a color change from blue to red is directly proportional to the concentration of the analyte present in the sample.

Although FIG. 9 illustrates an embodiment of a device including multiple chambers along a flow path, application is not limited to the embodiment shown and alternative embodiments of the device of the present application can include any number of chambers to implement different sample preparation or processing steps. Although FIG. 9 illustrates chambers (i.e., reservoirs or wells) in which sample preparation reagents and/or probes can be disposed along a sample flow path, other devices can be envisioned in which various sample preparation reagents and/or probes can be disposed in zones along a flow path (for example, in the flow passage that forms the flow path).

FIG. 10 illustrates an embodiment of a detection device 340 including a sensor component 100 and flow path as previously described. In the embodiment shown, the sensor component 100 is interposed in the flow path between a first flow path portion 342 and a second flow path portion 344. As shown, the flow path is formed along a membrane 350 between opposed ends 350a and 350b of the membrane 350. The membrane 350 is formed of an absorbent body, such as a membrane formed from nitrocellulose, nylon, polystyrene, polypropylene, or other appropriate materials, having a pore size that facilitates flow along (i.e., flow through) the membrane 350 to form the flow path and the first and second flow path portions 342, 344 of the device 340. The sensor component 100 includes a sensor layer or portion 352 that is deposited on the membrane along an intermediate portion of the membrane 100. In the illustrated embodiment, an absorbent pad 354 is coupled to the membrane 350 downstream of the sensor component 100 to induce fluid flow along the membrane 350 from the first flow path portion 342 past the sensor component 100 to the second flow path portion 344. The absorbent pad 354 can be made of a material such as glass fiber, cellulose, etc.

In an exemplary embodiment, the membrane is formed of a nitrocellulose material, for example. In an exemplary embodiment, the sensor layer or portion 352 is coated on the membrane 350 in a thin stripe averaging 2-3 millimeters (mm) in width and a having coating weight of 4-100 microliters per centimeter squared (μL/cm²) depending upon the configuration of the device. For use in an assay, sample preparation reagents (e.g., mucolytic or lysis reagents) could be spotted upstream of the sensor layer or portion 352, near where the specimen is added to the nitrocellulose material, for example.

In an exemplary embodiment illustrated in FIG. 11, where like numbers are used to refer to like parts in FIG. 10, the device 340-1 includes a pad 358 upstream of the sensor component 100. The pad 358 includes a probe that is mixed with a test sample as previously described for an indirect assay. Alternatively, or additionally, the pad 358 could include one or more sample preparation reagents. The pad 358 can be made of a material such as cellulose or glass fiber filters, for example.

One or more sample preparation reagents can be added together or separately, in separate zones in the fluid path (of the devices of FIGS. 10 and 11) such that several specimen treatments can occur sequentially in the fluid path. These zones can be constructed by placing different materials coated with different sample preparation reagents in the path or by coating the materials directly in the fluid path. These constructions would allow for sequential specimen treatments in flow paths where this is advantageous for downstream detection.

If the devices of FIGS. 10 and 11 are used in an indirect assay, the reagent probe and the analyte-containing sample of interest can be first mixed in a tube, for example, a micro-centrifuge tube. After mixing is completed, a first end of the membrane 350 (i.e., 350a) can be inserted into the micro-centrifuge tube containing the probe/analyte mixture. At this point the mixture will typically start to flow along the membrane 350 via capillary action. When the solution reaches the sensor component 100, probe that is not bound to the target analyte present can induce a visible color change of the sensor component 100. The assay can be designed such that when the analyte concentration exceeds a certain threshhold, the unbound probe concentration is below what can be detected by the sensor component 100. In such an indirect assay, a color change indicates that the concentration of analyte is below the threshhold, while no visible color change indicates an analyte concentration that is above the threshhold value.

If the devices of FIGS. 10 and 11 are used in a direct assay, the sensor component 100 includes a receptor such that when the analyte contacts the sensor component 100 it binds to this receptor and triggers a visible color change in the sensor component 100. In this case, a first end of the membrane can be inserted into the micro-centrifuge tube containing the sample to be analyzed. At this point the sample solution will typically start to flow along the membrane 350 via capillary action. When the solution reaches the sensor component 100, the target analyte present can induce a visible color change of the sensor component 100. The assay can be designed such that when the analyte concentration exceeds a certain threshhold, it can induce a complete color change of the sensor component 100. In such a direct assay, a color change indicates that the concentration of analyte is above the threshhold, while no visible color change indicates an analyte concentration that is below the threshhold value.

Use of the exemplary device of FIG. 11 with a probe disposed on or in conjugate pad 358, in an indirect assay can eliminate the need to mix the reagent probe and the analyte-containing sample prior to contact with the device. The analyte-containing sample can simply be dropped onto the conjugate pad 358 using a pipette or a syringe. As the sample wets the pad 358, the reagent probe reconstitutes into the solution and can mix with the target analyte. The rest of the indirect assay is identical to that described above.

Use of the exemplary device of FIG. 11 in a direct assay allows one to use a sample preparation reagent. For example, the target analyte may need to be lysed in order to release a protein target that is detectable. In such a case, the lysing agent could be incorporated into the pad 358. As the analyte sample wets the pad 358, the lysing reagent reconstitutes into the solution and can mix with the target analyte to lyse it and release the detectable protein. The rest of the direct assay is identical to that described above.

Exemplary devices suitable for the lateral-flow embodiments disclosed herein are described, for example, in U.S. Pat. No. 5,753,517 or U.S. Pat. No. 6,509,196, and U.S. Patent Application Publication Nos. 2003/0162236 and 2003/0199004, for example. Such devices can be used for both sample preparation and analysis.

For example, in one embodiment, the present invention provides a device that includes: a sample flow path; a zone including a sensor component; one or more reagents for sample preparation disposed in one or more distinct zones of the sample flow path ahead (i.e., upstream) of the sensor component; and optionally, a probe disposed in a distinct zone of the sample flow path ahead of the sensor component and different from the one or more sample preparation reagents.

In another embodiment, the present invention provides a device for sample preparation and analysis of a target analyte, wherein the device includes: a sample flow path; one or more reagents for sample preparation disposed in one or more distinct zones of the sample flow path; a zone including a probe disposed in the sample flow path downstream from at least one of the sample preparation reagents; and a zone including a colorimetric sensor component, wherein the colorimetric sensor comprises a polymerized composition comprising a diacetylene-containing polymer and a receptor, wherein the receptor is incorporated in the polymerized composition to form a transducer that provides a color change upon binding with one or more probes and/or analytes.

FIG. 12 schematically illustrates another embodiment of a detection device 380 that includes a sensor component 100 in a flow path between a first flow passage portion 382 (defining a first flow path portion) and second flow passage portion 384 (defining a second flow path portion) within a body 386 of the device. In the embodiment shown, the sensor component 100 includes a sensor layer or portion 130 on a flow-through membrane 390. The membrane 390 and sensor layer or portion 130 are disposed in the flow path and separate the first flow passage portion 382 and the second flow passage portion 384. In the illustrated embodiment, the sample is introduced into the first flow passage portion 382 at inlet 392 (illustrated schematically) and flows through the flow-through membrane 390 from the first flow passage portion 382 to the second flow passage portion 384. Sample flow is discharged from the second flow passage portion 384 at outlet 394. As described, the sensor layer or portion 130 includes the receptor that is configured to bind with the analyte or probe as the sample flows past the sensor layer or portion 130 and through the flow-through membrane 390. Upon binding, the sensor component 100 undergoes a detectable change to detect the presence of the analyte and/or probe, as previously described.

The flow-through membrane 390 can be a porous membrane having a small pore size (e.g., 200 micrometers (μm)). Exemplary flow-through membranes can be formed of polyethersulfone (available under the trade designation SUPOR from Pall Corporation, Ann Arbor Mich.—0.2, 0.45 μm); polysulfone (I.C.E. or Tuffryn from Pall Corporation, Ann Arbor Mich.—0.4 μm); Cellulose Ester (MF Millipore from Millipore Corporation, Billerica Mass.—0.4 μm); Polycarbonate (G.E. Polycarbonate Membranes from G.E. Osmonics, Minnetonka, Minn.—0.2 μm, 0.4 μm), or other material that has desired flow-through characteristics and sensor compatibility. In one embodiment, the sensor layer or portion 130 includes diffused liposomes in the pores of flow-through membrane 390. In illustrated embodiments, the coating weight of the liposomes is relative low, for example, approximately 12 μL/cm².

FIG. 13 illustrates another embodiment of a detection device 400 that includes a flow-through membrane 402 having a sensor layer or portion 130 separating a first flow passage portion 406 and a second flow passage portion 408 of the flow path. In the illustrated embodiment, the flow-through membrane 402 is disposed in a tube 410 which forms a body of the device 400 and the first and second flow passage portions 406, 408 of the device 400. In the illustrated embodiment, the flow-through membrane 402 is supported in tube 410 on a support 414 disposed in the flow path between the first and second flow passage portions 406, 408.

As shown in the illustrated embodiment, the support 414 includes a plurality of filter layers 416, which abut a tapered portion of the tube 410. Application, however, is not limited to the particular support 414 including the plurality of filter layers 416 as shown. The flow-through membrane 402 abuts the support 414. As cooperatively shown in FIGS. 13-14, opposed surfaces of the flow-through membrane 402 include adhesive layers 420, 422. The adhesive layer 422 connects the flow-through membrane 402 to support 414. As shown, the adhesive layers 420, 422 have a void or open space which cooperatively forms a sensor passageway 424 between the first and second flow passage portions 406, 408. The sensor passageway 424 is narrower than the first and second flow passage portions 406, 408 in order define a specific area of flow, and to concentrate sample flow to the sensor layer or portion 130, which is formed on the flow-through membrane 402 in the sensor passageway 424.

Thus, for fabrication, the sensor layer or portion 130 in deposited within an inner area of the flow-through membrane 402 and the adhesive layers 420, 422 are positioned about the outer circumference of the flow-through membrane 402 to form the sensor passageway 424. In the illustrated embodiment, the sensor layer or portion is deposited on a single side of the flow-through membrane 402 while the adhesive layer or portions 420, 422 are disposed on both sides of the flow-through membrane 402. However, application is not limited to the specific embodiments shown. As shown, flow is induced through the detection device 400 along the flow path and through the sensor passageway 424 via a vacuum source 430. However, application is not limited to a vacuum source 430 to induce fluid flow and other techniques can be used, as previously described.

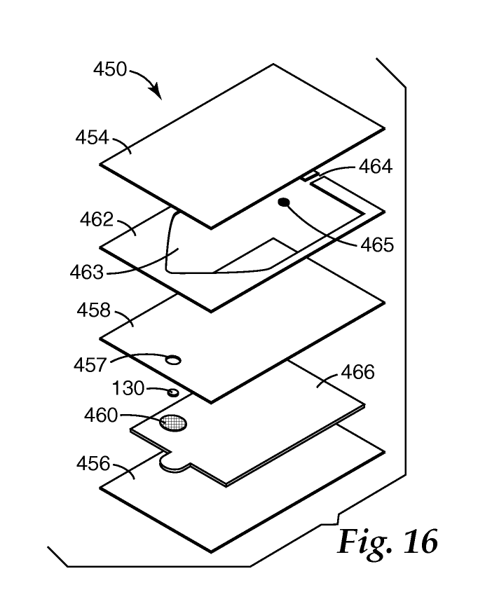

FIGS. 15-16 illustrate an embodiment of a detection device 450 (an enclosed vertical well device) having a sensor layer or portion 130 and flow-through membrane 460 where a body of the device is formed of a multiple layer construction. As shown, the multiple layer construction includes a face or first outer layer 454, a backing or second outer layer 456 and one or more intermediate layers. In the embodiment shown, the sensor component 100 is supported proximate to an opening 457 through intermediate layer 458. Sensor layer or portion 130 is disposed on membrane 460, which is coupled to the intermediate layer 458 proximate to opening 457. The multiple-layered structure also includes a spacer layer 462 disposed between the face layer 454 and intermediate layer 458. The spacer layer 462 is patterned to form inlet 464 (shown in FIG. 16) and the first flow path portion. An absorbent layer 466 is disposed between the intermediate layer 458 and the backing layer 456 proximate to the opening 457 to induce fluid flow across a sensor passageway formed through the flow-through membrane 460 in opening 457. In this embodiment, layers 454, 462, and 458 form an enclosed vertical well (i.e., reservoir or chamber) 463 with layers 454 and 458 forming the walls of the well 463 and the walls of the inlet 464.

As described, the first flow path portion is formed of a passage orientated along a length of the multiple-layered construction between the face layer 454 and the intermediate layer 458 to provide flow in a first direction. The device also includes a second flow path portion formed traverse to the first flow path portion to provide flow in a second direction generally transverse to the first direction across the flow-through membrane 460. In the illustrated embodiment, the face layer 454 can be formed of a transparent or see-through film so that the sensor component 100 is visible to discern the detectable change upon reaction of the analyte with the sensor component 100. Alternatively, a portion of the face layer 454 can be transparent or see-through to view the sensor component 100.

In the illustrated embodiment, fluid flow is induced across the flow-through membrane 460 via the absorbent layer 466. Layer 466 can be patterned to form an absorbent area downstream of the flow-through membrane 460 to form the traverse flow path or passage. Although FIGS. 15-16 illustrate a separate backing or outer layer 456, in alternate embodiments, the absorbent layer 466 can form the backing layer of the device, and application is not limited to the specific layers shown.

During use of the embodiments of FIGS. 15-16, a fluidic sample enters the enclosed vertical well 463 through inlet 464 and the fluid accumulates therein. If desired, sample preparation reagents (illustrated, for example, by the spot 465) can be placed at any locations in the fluid path that would allow for treatment prior to detection (i.e., in the fluid flow path upstream of the sensor component 100). Although only one well (or reservoir) 463 is shown, this embodiment could include several different “reservoirs” that allow for fluid “accumulation.” This can facilitate sample preparation (i.e., treatment), for example, by either mixing with a probe or sample preparation reagent in the reservoirs, either sequentially or simultaneously.

In each of the illustrated embodiments a time or period of exposure of the test sample to the sensor component 100 is limited based upon the flow rate of the test sample across the sensor component 100. Once the fluid flows past the sensor component 100 it is no longer exposed to the sensor layer or portion, thus limiting exposure of the test sample to the sensor component 100 to provide a relatively stable test result which does not vary significantly following conclusion of the test.

The device of FIGS. 15-16 can be constructed using the following materials: layer 456 can be a vinyl tape (SCOTCH Super 33 Plus Vinyl Electrical Tape available from 3M Company, St. Paul Minn.), layer 466 can be a glass fiber wicking material (Sterlitech GB 140 Glass Fiber, available from Sterlitech Corporation, Kent Wash.), layer 460 can be a 450-nm porosity polyethersulfone membrane (Pall SUPOR 450 Membrane, available from Pall Corporation, Ann Arbor Mich.), layer 458 can be a 0.8-mm thick polyvinyl chloride (PVC) backing material with a pressure sensitive adhesive on one side (Diagnostic Consulting Network Miba-010, available from Diagnostic Consulting Network, Irvine Calif.), layer 462 is a 1.6-mm thick 3M Polyethylene blown foam with a pressure sensitive adhesive on both sides (available from 3M Medical Division, 3M Company, St. Paul Minn.), and layer 454 can be a 3M Polyester General Use Transparency Film (available from 3M Company, St. Paul Minn.). To construct the detection device, each of the film layers can be die cut to its proper shape and size using a rotary die. The assembly begins by placing the flow-through filter membrane 460 over the opening 457 on the adhesive side of the intermediate layer 458. Next, the absorbent layer 466 can be placed over the filter membrane and positioned over the opening 457 on the adhesive side of the intermediate layer 458. This initial laminate can be placed absorbent layer 466 down on the adhesive side of the backing layer 456, applying pressure at the edges to ensure that the backing layer 456 adheres around the absorbent layer 466 to the intermediate layer 458, forming a seal. Next, the liner from one side of the spacer layer 462 can be removed and the adhesive side of the spacer layer 462 laminated to the non-adhesive side of the intermediate layer 458. Finally, the liner from the other side of the spacer layer 462 can be removed, and the outer layer 454 laminated to the adhesive layer on the spacer layer 462. A needle can be used to create two vent holes located at the top of the sample chamber.

The sensor components of any of the devices of the present invention are typically coated, deposited, or otherwise formed within the devices prior to use. Test samples with optional probes therein can then be introduced into the devices for interaction with the sensor components. Although the devices are described herein as if the sensor components have been incorporate therein prior to use, it will be understood by one of skill in the art that the sensor components in such devices can be formed in situ. That is, the sensor components of the devices described herein can be deposited in or on a flow-through membrane (during sample analysis) while in the presence of one or more target analytes and/or probes.

The devices of FIG. 13-16 can be used similarly for both indirect and direct assays. In one embodiment of an indirect assay, for example, a sample containing the target analyte is typically first mixed with a reagent probe. After completing this step, a sensor component in solution can then be added to the probe/analyte mixture. At this point, probe that is not bound to the target analyte will induce a visible color change of the sensor component in solution. The extent of the color change is inversely proportional to the amount of analyte initially present in the sample. The final solution mixture can then be introduced into any of the devices shown in FIGS. 13-16 where the sensor component can be collected and concentrated on the flow-through membrane (e.g., membrane 402 of FIG. 13 or membrane 460 of FIG. 16) to form the sensor layer 130 during the process (i.e., in situ), allowing the user to visualize the result of the assay.

Alternatively, the sensor component could be incorporated into the devices of FIGS. 13-16 as a coated sensor layer 130 on the flow-through membrane (e.g., membrane 402 of FIG. 13 or membrane 460 of FIG. 16). In this mode, in an indirect assay, the sample containing the target analyte is typically first mixed with a reagent probe. After mixing, the probe-analyte mixture is introduced into any of the devices shown in FIGS. 13-16 and allowed to flow through the sensor layer 130 and the flow-through membrane (e.g., membrane 402 of FIG. 13 or membrane 460 of FIG. 16) at a given flow rate. As the sample solution passes through the sensor layer, probe that is not bound to the target analyte can induce a visible color change of the sensor layer 130. The extent of the color change will then typically be inversely proportional to the amount of analyte initially present in the sample.

In a direct assay, the sensor component includes a receptor such that when the analyte contacts the sensor component it binds to this receptor and triggers a visible color change. In one embodiment, the sensor component can be in solution can be added to the analyte-containing sample. This solution mixture can then be introduced into any of the devices of FIGS. 13-16 where the sensor component can be collected and concentrated to form the sensor layer 130 (during the detection process) on the flow through membrane (e.g., membrane 402 of FIG. 13 or membrane 460 of FIG. 16), allowing the user to visualize the result of the assay. The extent of the color change will typically be directly proportional to the amount of analyte initially present in the sample.

Alternatively, the sensor component could be incorporated in the devices of FIGS. 13-16 as a coated sensor layer 130 on the flow-through membrane (e.g., membrane 402 of FIG. 13 or membrane 460 of FIG. 16). In this mode, for use in an direct assay, the sample containing the analyte is simply introduced into any of the devices of FIGS. 13-16 and allowed to flow through the sensor layer 130 and the flow-through membrane (e.g., membrane 402 of FIG. 13 or membrane 460 of FIG. 16) at a given flow rate. As the sample solution passes through the sensor layer, analyte can bind with the receptor incorporated in the sensor component, inducing a visible color change of the sensor layer 130. The extent of the color change will be directly proportional to the amount of analyte initially present in the sample.

The discussion of exemplary embodiments herein above is primarily directed to a sensor (i.e., sensor component) disposed in a device in a sample flow path; however, other reagents used in detection (e.g., probes) and/or reagents used in sample preparation (e.g., lysing agent) can be disposed in the device in the sample flow path as well. Reagents can be separated within such devices by a variety of well-known mechanisms. For example, a portion of a flow path can include one reagent (e.g., sample preparation reagent) and be separated from another portion of the flow path with another reagent therein (e.g., probe) by a valve therebetween made of a material (e.g., such as a hydrogel) that could dissolve upon contact with the sample. Other mechanisms of separation include, for example, membranes/materials of different porosities or fluid flow rates.

The embodiments described herein are exemplary in nature. It will be understood by one of skill in the art that other devices having other physical structures can be used to carry out the methods of the present invention. Furthermore, the specific devices described herein can be used in various methods (as would be appreciated by one of skill in the art) other than those specifically described.

The complete disclosures of all patents, patent applications, publications, and nucleic acid and protein database entries, including for example GenBank accession numbers, that are cited herein are hereby incorporated by reference as if individually incorporated. Various modifications and alterations of this invention will become apparent to those skilled in the art without departing from the scope and spirit of this invention, and it should be understood that this invention is not to be unduly limited to the illustrative embodiments set forth herein.

1. A device for detecting the presence or absence of an analyte, the device comprising:
a body including a flow path, a flow-through membrane, and a colorimetric sensor component disposed in or on the flow-through membrane;
wherein the colorimetric sensor comprises a polymerized composition comprising a diacetylene-containing polymer and a receptor, wherein the receptor is incorporated in the polymerized composition to form a transducer that provides a color change upon binding with one or more probes and/or analytes.

2. The device of claim 1 further comprising one or more reagents for sample preparation disposed in one or more distinct zones of the sample flow path within the body of the device, wherein the one or more zones are disposed in the sample flow path upstream from the colorimetric sensor.

3. The device of claim 1 further comprising one or more probes for indirect analyte detection disposed in one or more distinct zones of the sample flow path within the body of the device, wherein the one or more zones are disposed in the sample flow path upstream from the colorimetric sensor.

4. The device of claim 1 wherein the sensor component includes polydiacetylene liposomes.

5. The device of claim 1 wherein the sensor component comprises a patterned sensor layer in a form of one or more symbols or text.

6. The device of claim 1 wherein the flow path comprises a first flow passage portion and a second flow passage portion forming first and second flow path portions, wherein the flow-through membrane divides the first and second flow passage portions.

7. The device of claim 6 and including a pressure source to induce flow from the first flow path portion to the second flow path portion past the sensor component.

8. The device of claim 7 wherein the pressure source is one of a syringe, vacuum source, absorbent pad, or capillary pressure.

9. The device of claim 1, which is a lateral-flow device.

10. The device of claim 1, which is a vertical-flow device.

11. The device of claim 1, wherein the sample flow path comprises at least two portions, one of which is transverse to the other.

12. The device of claim 1, wherein the colorimetric sensor component is deposited in or on the flow-through membrane while in the presence of one or more target analytes and/or probes.

13. A device for detecting the presence or absence of an analyte, the device comprising:
a body including a flow path and a plurality of layers forming a multiple-layered structure,
the flow path defined by a first flow passage portion and a second flow passage portion formed between a first layer and a second layer; and
a sensor component disposed between the first and second layers, wherein the sensor component separates the first flow passage portion from the second flow passage portion.

14. The device of claim 13, wherein the sensor component comprises a colorimetric sensor.

15. The device of claim 14, wherein the colorimetric sensor comprises a polymerized composition comprising a diacetylene-containing polymer and a receptor, wherein the receptor is incorporated in the polymerized composition to form a transducer that provides a color change upon binding with one or more probes and/or analytes.

16. The device of claim 13 further including one or more intermediate layers between the first layer and the second layer, wherein the intermediate layer includes a patterned portion that forms at least one of the first and second flow passage portions.

17. The device of claim 16 further comprising a flow-through membrane disposed in an opening in at least one of the intermediate layers.

18. The device of claim 13, wherein the multiple-layered structure includes first and second outer layers, a spacer layer, and an intermediate layer, wherein the intermediate layer is disposed between the first and the second outer layers, and the spacer layer is disposed between the first outer layer and the intermediate layer and forms a first flow passage portion along the multiple-layered structure.

19. The device of claim 18 further comprising a flow-through membrane disposed in an opening of the intermediate layer.

20. The device of claim 17 further comprising an absorbent layer or portion between an intermediate layer and an outer layer to induce flow across the flow-through membrane.

21. The device of claim 13, wherein the first layer includes a see-though portion to view the sensor component.

22. The device of claim 13 further comprising one or more chambers disposed within the first flow passage portion.

23. The device of claim 22, wherein at least one of the one or more chambers includes a sample preparation reagent and/or a probe disposed therein.

24. The device of claim 13, wherein the first flow passage portion is tortuous.

25. The device of claim 13, wherein the first and second flow passage portions are orientated in different directions.

26. The device of claim 13, wherein the sensor component is disposed in or on a flow-through membrane between the first and second layers.

27. The device of claim 26, wherein the sensor component is deposited in or on the flow-through membrane while in the presence of one or more target analytes and/or probes.

28. A device for detecting the presence or absence of an analyte, the device comprising:
a body including a flow path and a plurality of layers forming a multiple-layered structure,
the flow path defined by a first flow passage portion and a second flow passage portion formed between a first layer and a second layer;
a patterned layer interposed between the first layer and the second layer, wherein the patterned layer forms a chamber, the first flow passage portion, and the second flow passage portion, and
a sensor component disposed in the chamber formed by the patterned layer.

29. The device of claim 28 further comprising one or more additional chambers disposed within the first flow passage portion.

30. The device of claim 29, wherein at least one of the one or more additional chambers includes a sample preparation reagent and/or a probe disposed therein.

31. The device of claim 28, wherein the sensor component is formed or deposited on a substrate enclosed within the chamber.

32. The device of claim 28, wherein the sensor component is formed or deposited on at least one of the first layer or the second layer.

33. The device of claim 28, wherein the sensor component comprises a colorimetric sensor.

34. The device of claim 33, wherein the colorimetric sensor comprises a polymerized composition comprising a diacetylene-containing polymer and a receptor, wherein the receptor is incorporated in the polymerized composition to form a transducer that provides a color change upon binding with one or more probes and/or analytes.

35. The device of claim 28, wherein the first flow passage portion is tortuous.

36. The device of claim 28, wherein the sensor component is disposed in or on a flow-through membrane within the chamber formed by the patterned layer.

37. The device of claim 36, wherein the sensor component is deposited in or on the flow-through membrane while in the presence of one or more target analytes and/or probes.

38. A device comprising:
a sample flow path;
a zone including a sensor component;
one or more reagents for sample preparation disposed in one or more distinct zones of the sample flow path ahead of the sensor component; and
optionally, a probe disposed in a distinct zone of the sample flow path ahead of the sensor component and different from the one or more sample preparation reagents.

39. The device of claim 38, wherein the sensor component is disposed in or on a flow-through membrane.

40. The device of claim 38, wherein the one or more reagents, and the optional probe are disposed on or in a flow-through membrane.

41. The device of claim 38, wherein the sensor component comprises a patterned layer in a form of one or more symbols or text.

42. The device of claim 38, which is a lateral-flow device.

43. The device of claim 38, which is a vertical-flow device.

44. The device of claim 38, wherein the sample flow path comprises at least two portions, one of which is transverse to the other.

45. The device of claim 38, wherein the sensor component comprises a colorimetric sensor.

46. The device of claim 45, wherein the colorimetric sensor comprises a polymerized composition comprising a diacetylene-containing polymer and a receptor, wherein the receptor is incorporated in the polymerized composition to form a transducer that provides a color change upon binding with one or more probes and/or analytes.

47. A device for sample preparation and analysis of a target analyte, the device comprising:
a sample flow path;
one or more reagents for sample preparation disposed in one or more distinct zones of the sample flow path;
a zone including a probe disposed in the sample flow path downstream from at least one of the sample preparation reagents; and
a zone including a colorimetric sensor component, wherein the colorimetric sensor comprises a polymerized composition comprising a diacetylene-containing polymer and a receptor, wherein the receptor is incorporated in the polymerized composition to form a transducer that provides a color change upon binding with one or more probes and/or analytes.

48. A method comprising:
providing a test sample suspected of containing one or more target analytes;
providing a device of claim 1, wherein the device comprises a sensor component prior to contact with a test sample;
optionally, providing one or more probes suitable for an indirect assay of the one or more target analytes;
inducing flow of a test sample from a first flow path portion to a second flow path portion downstream of the sensor component;
exposing the test sample to the sensor component to bind one or more target analytes and/or one or more probes to the sensor component to induce a detectable change in the sensor component, if the target analytes are present in the test sample; and
discerning the detectable change in the sensor component upon binding with the target analytes and/or probes.

49. The method of claim 48, wherein the one or more probes are disposed in the device in the first flow path portion.

50. A method of preparing and analyzing a sample for the presence or absence of an analyte, the method comprising:
providing a test sample suspected of containing one or more target analytes;
providing a device of claim 38, wherein the device comprises a sensor component and one or more sample preparation reagents;
inducing flow of a test sample from a first flow path portion to a second flow path portion downstream of the sensor component;
providing conditions effective for reaction between the test sample and at least one of the sample preparation reagents in the first flow path portion;
exposing the test sample to the sensor component under conditions effective to bind an analyte and/or probe to the sensor component and produce a detectable change; and
discerning the detectable change in the sensor component upon binding with the target analytes and/or probes.

51. A method of detecting the presence or absence of an analyte, the method comprising:
providing a device comprising:
a body including a flow path and a plurality of layers forming a multiple-layered structure, the flow path defined by a first flow passage portion and a second flow passage portion formed between a first layer and a second layer; and
a flow-through membrane disposed between the first and second layers, wherein the flow-through membrane separates the first flow passage portion from the second flow passage portion;
providing a test sample suspected of containing one or more target analytes;
optionally, providing one or more probes suitable for an indirect assay of the one or more target analytes;
providing a sensor component;
combining the test sample, optional probes, and sensor component to form a mixture;
inducing flow of the mixture from the first flow passage portion to the second flow passage portion across the flow-through membrane to collect the sensor component and bound target analytes and/or probes; and
discerning the detectable change in the sensor component upon binding with the target analytes and/or probes.

52. A method of detecting the presence or absence of an analyte, the method comprising:
providing a device comprising:
a body including a flow path and a plurality of layers forming a multiple-layered structure, the flow path defined by a first flow passage portion and a second flow passage portion formed between a first layer and a second layer;
a patterned layer interposed between the first layer and the second layer, wherein the patterned layer forms a chamber, the first flow passage portion, and the second flow passage portion, and
a flow-through membrane disposed in the chamber formed by the patterned layer;
providing a test sample suspected of containing one or more target analytes;
optionally, providing one or more probes suitable for an indirect assay of the one or more target analytes;
providing a sensor component;
combining the test sample, optional probes, and sensor component to form a mixture;
inducing flow of the mixture from the first flow passage portion to the second flow passage portion across the flow-through membrane in the chamber to collect the sensor component and bound target analytes and/or probes; and
discerning the detectable change in the sensor component upon binding with the target analytes and/or probes.
